(19) United States
(12) Patent Application Publication
(10) Pub. No.: US 2025/0278707 A1
(43) Pub. Date: Sep. 4, 2025

(54) PROTECTION ARCHITECTURE USING PROOF OF USAGE ON DISTRIBUTED LEDGERS

(71) Applicant: Wells Fargo Bank, N.A., San Francisco, CA (US)

(72) Inventors: Lalitha Ramakrishnan, San Francisco, CA (US); Govinda Rajulu Nelluri, Hyderabad (IN); Udaya Ramu Peethani, San Francisco, CA (US)

(73) Assignee: Wells Fargo Bank, N.A., San Francisco, CA (US)

(21) Appl. No.: 18/593,763

(22) Filed: Mar. 1, 2024

(51) Int. Cl. G06Q 20/10; G06Q 20/38; G06Q 20/40

(52) U.S. Cl. CPC G06Q 20/10; G06Q 20/381; G06Q 20/405

(57) ABSTRACT

Systems, methods, and computer-readable storage media to authorizing exchanges using a proof of usage model. One system includes memory and at least one processing circuit configured to generate a plurality of distributed ledger technology (DLT) networks and activate and connect a first network computing system to at least one of the DLT networks. The at least one processing circuit further configured to activate and connect a second network computing system to at least one of the DLT networks. The at least one processing circuit further configured to execute a disbursement of funds or digital asset corresponding with the first network computing system. The at least one processing circuit further configured to append a protection parameter to the funds or digital asset based on a scheme and in response to receiving an exchange request from the second network computing system, authorize an exchange based a proof of usage model.

### BACKGROUND

In a computer networked environment, users and entities like individuals or companies, may desire to verify usage of assets on networks.

### SUMMARY

Some arrangements relate to a system, including memory and at least one processing circuit configured to generate a plurality of distributed ledger technology (DLT) networks. The at least one processing circuit is further configured to activate and connect a first network computing system to at least one of the DLT networks. The at least one processing circuit is further configured to activate and connect a second network computing system to at least one of the DLT networks. The at least one processing circuit is further configured to execute a disbursement of funds or digital asset corresponding with the first network computing system. The at least one processing circuit is further configured to append a protection parameter to the funds or digital asset on at least one of the DLT networks based on a scheme, the scheme corresponding to restrictions on one or more usages of the funds or digital asset. The at least one processing circuit is further configured to in response to receiving an exchange request from the second network computing system, authorize an exchange for at least a portion of the funds or digital asset based on at least a consensus model and a proof of usage model on at least two of the plurality of DLT networks. The proof of usage model authorization occurs by at least one of the first network computing system or the second network computing system.

In some embodiments, a first DLT network of the plurality of DLT networks corresponds with the first network computing system, a second DLT network of the plurality of DLT networks corresponds with the second network computing system, and the protection parameter corresponds to executable code added to the exchange on the plurality of DLT networks by the at least one processing circuit to restrict or authorize a future exchange.

In some embodiments, the proof of usage model, implemented by the at least one processing circuit, includes confirming a usage of at least the portion of the funds or digital asset based on complying with one or more smart contracts enforcing one or more usage conditions of the protection parameter on the first DLT network, the one or more usage conditions including at least one of a category restriction on the funds or digital asset, a geographical restriction on the funds or digital asset, a temporal restriction on the funds or digital asset and adhering to one or more authorized expenditures encoded within context packets on the second DLT network.

In some embodiments, the context packets correspond to digitally encoded metadata including the one or more authorized expenditures for usage of the funds or digital asset under the scheme, the one or more authorized expenditures correspond with a merchant specific data structure including an authorized list of goods or services, or identifiers or values corresponding with the authorized list of goods or services.

In some embodiments, the first network computing system and the second network computing system are external to the plurality of DLT networks, and wherein activating and connecting includes initializing operational parameters of the first network computing system and the second network computing system and establishing a plurality of communication channels with participating nodes within the first DLT network and the second DLT network.

In some embodiments, the at least one processing circuit is further configured to maintain, by the first network computing system, the proof of usage model on a first DLT network of the plurality of DLT networks, wherein maintaining the proof of usage model includes dynamically updating one or more usage conditions of the protection parameter in response to at least one change in a rule or policy by a regulatory computing system and dynamically updating a data structure of the exchange to include a proof of usage indicator corresponding with a current compliance status of the exchange based on the enforced protection parameter.

In some embodiments, the at least one processing circuit is further configured to maintain, by the second network computing system, the proof of usage model on a second DLT network, wherein maintaining the proof of usage model includes integrating context packets encoded with one or more authorized expenditures into one or more smart contracts corresponding with enforcing the one or more authorized expenditures on the funds or digital asset on the second DLT network and analyzing and authorizing the exchange based on satisfying the one or more usage conditions of the protection parameter and the one or more authorized expenditures encoded within context packets.

In some embodiments, a first DLT network of the plurality of DLT networks includes an initiating participating node, a facilitating participating node, and a plurality of beneficiary participating nodes, the initiating participating node configured to initiate fund or digital asset disbursement exchanges, the facilitating participating node configured to execute one or more smart contracts corresponding with the fund or digital asset disbursement and append the exchange to include the protection parameter based on the scheme, the plurality of beneficiary participating nodes configured to receive and authorize the exchange of at least the portion of the funds or digital asset in accordance with the protection parameter, and a second DLT network of the plurality of DLT networks includes a plurality of merchant participating nodes, the plurality of merchant participating nodes configured to authorize the exchange based on the proof of usage model provided by the second network computing system and execute, using the consensus model, consensus decision-making for exchange authorization or rejection.

In some embodiments, upon receiving an indication of an emergency from a regulatory computing system, the at least one processing circuit updates the one or more usage conditions based on an updated scheme provided by the regulatory computing system, and wherein executing the disbursement of the funds or digital asset is in response to receiving a disbursement request based on the scheme.

Some arrangements relate to a system, including at least one integration computing system configured to generate a first distributed ledger technology (DLT) network including a plurality of beneficiary participating nodes. The least one integration computing system is further configured to generate a second DLT network including a plurality of merchant participating nodes. The least one integration computing system is further configured to activate and connect a beneficiary network computing system to the first DLT network. The least one integration computing system is further configured to activate and connect a merchant network computing system to the second DLT network. The least one integration computing system is further configured to receive a disbursement request based on a scheme. The system further includes the beneficiary network computing system configured to execute, on the first DLT network, a disbursement corresponding with funds or digital asset based on the disbursement request. The beneficiary network computing system is further configured to append a protection parameter based on the scheme to the funds or digital asset. The beneficiary network computing system is further configured to store, on a ledger of the first DLT network, the funds or digital asset. The beneficiary network computing system is further configured to in response to receiving an exchange request for an exchange from at least one of the plurality of merchant participating nodes, authorize the exchange for at least a portion of the funds or digital asset on the first DLT network based on at least a first consensus model and a proof of usage model. The system further includes the merchant network computing system configured to provide the exchange request to the at least one integration computing system for at least the portion of the funds or digital asset. The merchant network computing system is further configured to in response to receiving an indication of authorization of the exchange on the first DLT network, authorize the exchange on the second DLT network for at least the portion of the funds or digital asset based on at least a second consensus model and the proof of usage model.

In some embodiments, the protection parameter corresponds to executable code added to the exchange on the first DLT network by the beneficiary network computing system to restrict or authorize a future exchange, and wherein the first consensus model is different from the second consensus model.

In some embodiments, the proof of usage model, implemented by the beneficiary network computing system and the merchant network computing system, includes confirming a usage of at least the portion of the funds or digital asset based on complying with one or more smart contracts enforcing one or more usage conditions of the protection parameter on the first DLT network, the one or more usage conditions includes at least one of a category restriction on the funds or digital asset, a geographical restriction on the funds or digital asset, a temporal restriction on the funds or digital asset, and wherein upon receiving an indication of an emergency from a regulatory computing system, the at least one processing circuit updates the one or more usage conditions based on an updated scheme provide by the regulatory computing system and adhering to one or more authorized expenditures encoded within context packets on the second DLT network.

In some embodiments, the context packets correspond to digitally encoded metadata including the one or more authorized expenditures for usage of the funds or digital asset under the scheme, the one or more authorized expenditures correspond with a merchant specific data structure including an authorized list of goods or services, or identifiers or values corresponding with the authorized list of goods or services.

In some embodiments, the beneficiary network computing system and the merchant network computing system are external to the first DLT network and the second DLT network, and wherein activating and connecting includes initializing operational parameters of the beneficiary network computing system and the merchant network computing system and establishing a plurality of communication channels with participating nodes within the first DLT network and the second DLT network.

In some embodiments, the first DLT network includes an initiating participating node, a facilitating participating node, and the plurality of beneficiary participating nodes the initiating participating node is configured to initiate fund or digital asset disbursement exchanges, the facilitating participating node is configured to execute one or more smart contracts corresponding with the fund or digital asset disbursement and append the exchange to include the protection parameter based on the scheme, and the plurality of beneficiary participating nodes is configured to receive and authorize the exchange of at least the portion of the funds or digital asset in accordance with the protection parameter, and the second DLT network includes the plurality of merchant participating nodes, the plurality of merchant participating nodes is configured to authorize the exchange based on the proof of usage model provided by the merchant network computing system and execute, using the second consensus model, consensus decision-making for exchange authorization or rejection.

Some arrangements relate to a method including generating, by at least one processing circuit, a plurality of DLT networks. The method further includes activating, by the at least one processing circuit, and connect a first network computing system on at least one of the DLT networks. The method further includes activating, by the at least one processing circuit, and connect a second network computing system on at least one of the DLT networks. The method further includes executing, by the at least one processing circuit, a disbursement of funds or digital asset corresponding with the first network computing system. The method further includes appending, by the at least one processing circuit, a protection parameter to the funds or digital asset on at least one of the DLT networks based on a scheme, the scheme corresponding to restrictions on one or more usages of the funds or digital asset. The method further includes in response to receiving an exchange request from the second network computing system, authorizing, by the at least one processing circuit, an exchange for at least a portion of the funds or digital asset based on at least a consensus model and a proof of usage model on at least two of the plurality of DLT networks, wherein the proof of usage model authorization occurs by at least one of the first network computing system or the second network computing system.

In some embodiments, a first DLT network of the plurality of DLT networks corresponds with the first network computing system, a second DLT network of the plurality of DLT networks corresponds with the second network computing system, and the protection parameter corresponds to executable code added to the exchange on the plurality of DLT networks by the at least one processing circuit to restrict or authorize a future exchange.

In some embodiments, the proof of usage model, implemented by the at least one processing circuit, includes confirming a usage of at least the portion of the funds or digital asset based on complying, by the at least one processing circuit, with one or more smart contracts enforcing one or more usage conditions of the protection parameter on the first DLT network, the one or more usage conditions including at least one of a category restriction on the funds or digital asset, a geographical restriction on the funds or digital asset, a temporal restriction on the funds or digital asset and adhering, by the at least one processing circuit, to one or more authorized expenditures encoded within context packets on the second DLT network.

In some embodiments, the context packets correspond to digitally encoded metadata including the one or more authorized expenditures for usage of the funds or digital asset under the scheme, the one or more authorized expenditures correspond with a merchant specific data structure including an authorized list of goods or services, or identifiers or values corresponding with the authorized list of goods or services.

In some embodiments, the first network computing system and the second network computing system are external to the plurality of DLT networks, and wherein activating and connecting includes initializing, by the at least one processing circuit, operational parameters of the first network computing system and the second network computing system and establishing, by the at least one processing circuit, a plurality of communication channels with participating nodes within the first DLT network and the second DLT network.

### BRIEF DESCRIPTION OF THE DRAWINGS

FIG. 1A is a block diagram depicting an example of a proof of usage (PoU) architecture, according to some arrangements.

FIG. 1B is a block diagram depicting an example of another PoU architecture, according to some arrangements.

FIG. 1C is a block diagram depicting an example of another PoU architecture, according to some arrangements.

FIG. 1D is a block diagram depicting an example of the PoU architecture of FIG. 1A including a PoU process, according to some arrangements.

FIG. 2 is a block diagram illustrating an example computing system suitable for use in the various arrangements described herein.

FIG. 3 is a flowchart for a method of authorizing exchanges using a PoU model, according to some arrangements.

FIG. 4 is a block diagram illustrating a PoU process, according to some arrangements.

FIG. 5 is a block diagram illustrating PoU integration into a blockchain, according to some arrangements.

It will be recognized that some or all of the figures are schematic representations for purposes of illustration. The figures are provided for the purpose of illustrating one or more embodiments with the explicit understanding that they will not be used to limit the scope or the meaning of the claims.

### DETAILED DESCRIPTION

Referring generally to the figures, systems, apparatuses, methods, and non-transitory computer-readable media for a proof of usage (PoU) model implemented on a PoU architecture. A Direct Benefit Transfer (DBT) scheme, a prevalent method for transferring financial benefits directly from an initiating entity such as government departments, administrative bodies, or corporate sectors to beneficiary accounts, serves to expedite payment processes and minimize revenue leaks. Yet, a significant limitation exists post-disbursement: the lack of control and traceability over the end-use of these funds. Once disbursed, there is no effective mechanism to monitor or regulate how recipients utilize these funds, leading to potential misuse, as evidenced in cases like the misuse of Paycheck Protection Program (PPP) funds in the U.S. for unintended activities like gambling or trading. Addressing this gap, the proposed proof of usage (PoU) model offers a significant improvement in managing and safeguarding the distribution and utilization of digital assets or funds across networks.

In some embodiments, PoU model introduces an improved DLT network architecture. By embedding smart contracts, context packets, and usage parameters within exchanges, it enables the initiating party, such as a government entity, to exert protection controls over how assets are utilized post-disbursement. This model further leverages the inherent transparency and immutability of blockchain technology to ensure that funds are used strictly as intended. For example, smart contracts can enforce usage restrictions based on categories, geography, or time, ensuring that beneficiaries spend the funds in alignment with the DBT scheme's objectives. These technical features enhances the security and integrity of the assets and align the asset distribution with the protection goals of the initiating entity. Furthermore, from a network perspective, the PoU model provides an additional layer of security and compliance to DLT networks. By integrating the proof of usage checks within the consensus process, the model ensures that all exchanges on the network adhere to the prescribed usage criteria. This integration results in a more robust and reliable network, where misuse of assets (e.g., funds) can be detected and prevented in real-time.

Additionally, the implementation of context packets and protection parameters in the proof of usage model (e.g., PoU algorithm, etc.) provides an improvement in asset protection over existing DLT architectures and proof mechanisms. Context packets, which contain encoded data about authorized expenditures, can be used in combination with protection parameters, such as embedded flags, to create a more controlled and secure environment for asset distribution and utilization. The dual mechanisms enhance the capability of the DLT network to regulate and monitor the flow of assets, ensuring they are used precisely as intended. For example, context packets can include detailed information about the types of goods or services that can be purchased with the distributed assets, tailored to specific DBT schemes. This information, when integrated into smart contracts, allows for automated checks against each exchange, verifying its compliance with the defined expenditure criteria. Additionally, the use of protection parameters, such as flags embedded in exchanges, adds another layer of security. These parameters act as markers that can trigger alerts or block transactions if they deviate from the prescribed usage conditions. Specifically, this improved level of control and security is particularly important in scenarios where the precise usage of funds is critical, such as in government aid programs or corporate disbursements. By integrating these advanced features into the DLT architecture, the proof of usage model effectively addresses the limitations of traditional proof mechanisms, offering a more robust, compliant, and secure framework for managing and protecting digital assets across networks.

As used herein, “smart contract” generally refers to a self-executing code (e.g., in a ledger network or other system) that executes when a set of conditions that have been agreed upon by the parties of the smart contract are met. Although the FIGS. and specification generally discuss utilizing smart contracts on funds or digital assets, the systems, methods, and apparatuses disclosed herein can also be used for a plurality of types of non-fungible or fungible assets, such as but not limited to commodities, common shares, options, dollar bills, fiat currency, digital currency, tokens, deeds, leases, wills, other exchanges, non-smart contracts, traditional legal contracts, financial disbursements, taxes, and other types of non-fungible or fungible assets parties use and exchange. Parties to the smart contract for funds or digital assets or other types of non-fungible or fungible assets may be individuals, companies, organizations, entities, providers, the government, and so on.

As used herein, a “proof of usage model (or PoU model)” generally refers to a system or methodology implemented within a blockchain or distributed ledger technology (DLT) network to ensure that transactions and digital assets adhere to specific usage criteria or conditions. This model employs smart contracts and other blockchain mechanisms to enforce compliance with predetermined rules or guidelines, such as those related to Direct Benefit Transfer (DBT) schemes. The PoU model (e.g., executed by a processing circuit of the network computing systems 120 and 130) validates the legitimacy and appropriateness of transactions by checking against these rules, which may include restrictions on categories of goods or services that can be purchased, geographical limitations on where the funds can be spent, or temporal constraints on when the funds are usable.

In some embodiments, the PoU model operates by embedding specific parameters or flags into transactions or by encoding a data structure of authorized expenditures within context packets, either individually or in combination, both which are then automatically checked against the conditions set in the smart contracts. This process ensures that every transaction aligns with the intended use of the funds or assets, as dictated by regulatory requirements or scheme guidelines. For example, in a DBT scheme like a Corona Relief Program, the PoU model would ensure that funds are only used for approved expenses, such as medical supplies or essential services. Moreover, the PoU model can be dynamically updated to reflect changes in policies or rules. In response to new regulations or shifts in program criteria, the smart contracts can be adjusted to incorporate these changes, allowing for flexible and timely adaptation to evolving requirements.

The PoU model functions in conjunction with traditional consensus mechanisms, such as proof of work or proof of stake, providing an additional layer of transaction validation that is directed to the usage and compliance aspects of digital assets and funds. This dual-layer approach improves the robustness and trustworthiness of the network by not only securing the ledger against fraudulent activities but also ensuring that all transactions meet the specific requirements and intentions of the underlying scheme or regulatory framework.

Specifically, Proof of Usage (PoU) differs from traditional consensus models like Proof of Work (PoW) or Proof of Stake (PoS) in its core objectives and operational mechanisms within a blockchain or Distributed Ledger Technology (DLT) network. While PoW and PoS are primarily concerned with maintaining the overall integrity and security of the blockchain, validating transactions, and achieving consensus among network participants, PoU focuses explicitly on ensuring compliance with specific usage policies or regulations tied to transactions and digital assets. PoU employs smart contracts to enforce predetermined rules, such as restrictions on how, where, and when funds or assets can be used, particularly in relation to specific schemes or regulatory requirements. This might involve checking transactions against criteria like authorized categories of expenditure, geographical spending limits, or time-bound usage constraints. In contrast, PoW and PoS mechanisms are designed to secure the network against double-spending and other fraudulent activities, typically involving computational challenges (in PoW) or stake-based participation (in PoS) to validate transactions and add new blocks to the chain. PoU adds a layer of compliance and usage verification to the transaction process, functioning alongside but distinctly from the general consensus mechanism of the blockchain.

It should be understood that “real-time” as used herein does not necessarily mean instantaneous, but rather refers to a process or system in which information is updated at a frequency that is suitable for its intended purpose, thereby enabling timely responses and decisions based on the most recent data available.

As used herein, a “digital asset” may be a data package or structure including information (e.g., values in fields) and an amount of digital or virtual currency that is owned by one or more parties (e.g., user, individual, institution, company, or so on) and used to perform exchanges (e.g., for goods or services) in a computer networked environment. The digital asset may be encrypted and decrypted using one or more public and private key pairs (sometimes referred to as a “verification and signing key pair”). In some arrangements, a digital asset may be a digital form of a fiat currency of one or more nations, one or more countries, or one or more regions. In some arrangements, the digital asset may be issued by a central provider (e.g., Federal Reserve System (FRS)), or by a specific provider (e.g., bank). The digital asset may be a cryptocurrency (e.g., Bitcoin, Ethereum, Stablecoin Tether (USDT), USD Coin (USDC)) or derived (for example, as a token) from cryptocurrency. The digital asset may be a central bank digital currency (CBDC) (e.g., Digital USD, Digital Euro, Digital Japanese Yen, Digital British Pound, Digital Swiss Franc) or derived (for example, as a token) from CBDC. In various arrangements, the digital asset can include information in one or more metadata fields that may be modified by the one or more parties. Furthermore, smart contracts can configured to provide one or more functionalities of the digital asset and can be wrapped into the data package or block data of the digital asset.

Additionally, in the context of the exchange process involving digital assets within DLT network, public and private key pairs can be used to ensure the security and integrity of exchanges. The key pairs can be used in the encryption and decryption process that safeguards the digital assets and validates transactions. For example, when a user initiates an exchange request on a first DLT network, their private key can be used to sign the transaction. This digital signature verifies that the transaction has been initiated by the rightful owner of the digital asset. The transaction, including details like the source identifier, destination identifier, and amount of MBC, is then encrypted using the user's private key. This encryption ensures that the transaction details remain secure and tamper-proof as they traverse the network. In this example, on the receiving end, the processing circuits associated with a second DLT network can use the sender's public key to decrypt and validate the exchange notification. The public key can decrypt the transaction encrypted by the corresponding private key, thereby confirming the authenticity and integrity of the transaction. Moreover, the process of creating a new block on the blockchain in both DLT networks can include the use of public and private keys. When a new block is created and added to the blockchain, it can be encrypted with a private key and can be verified by anyone on the network using the corresponding public key.

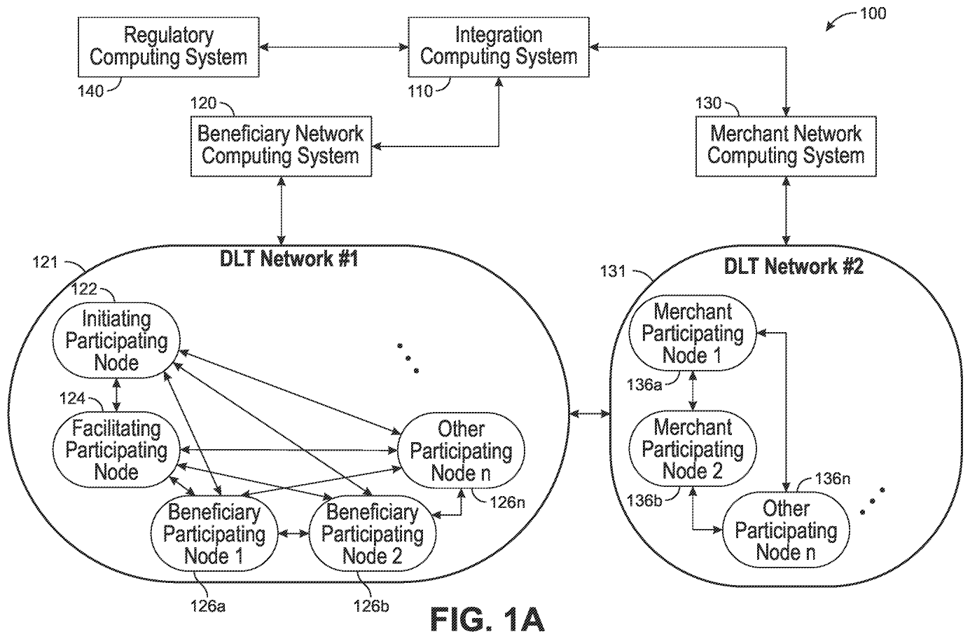

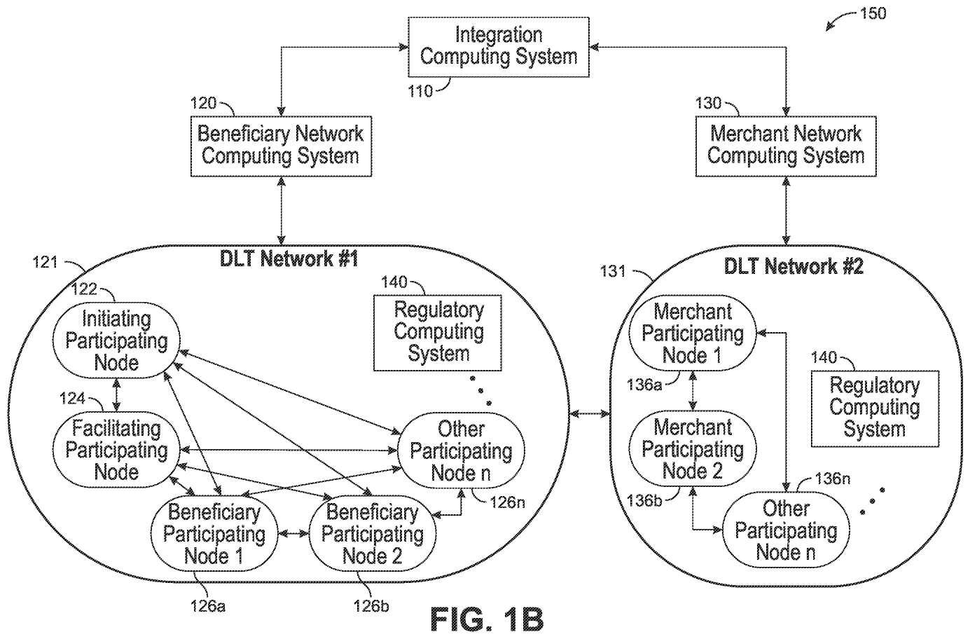

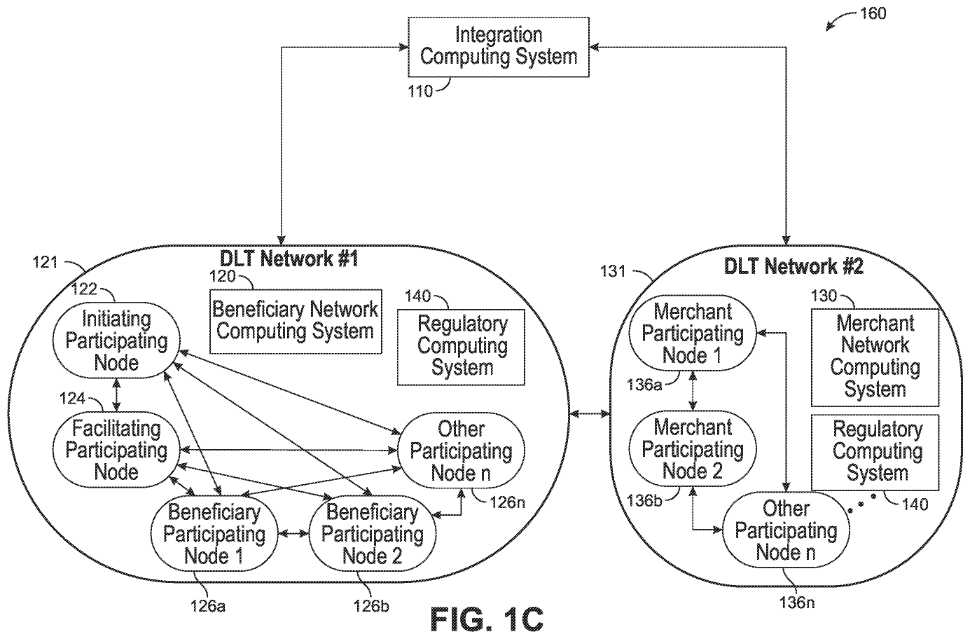

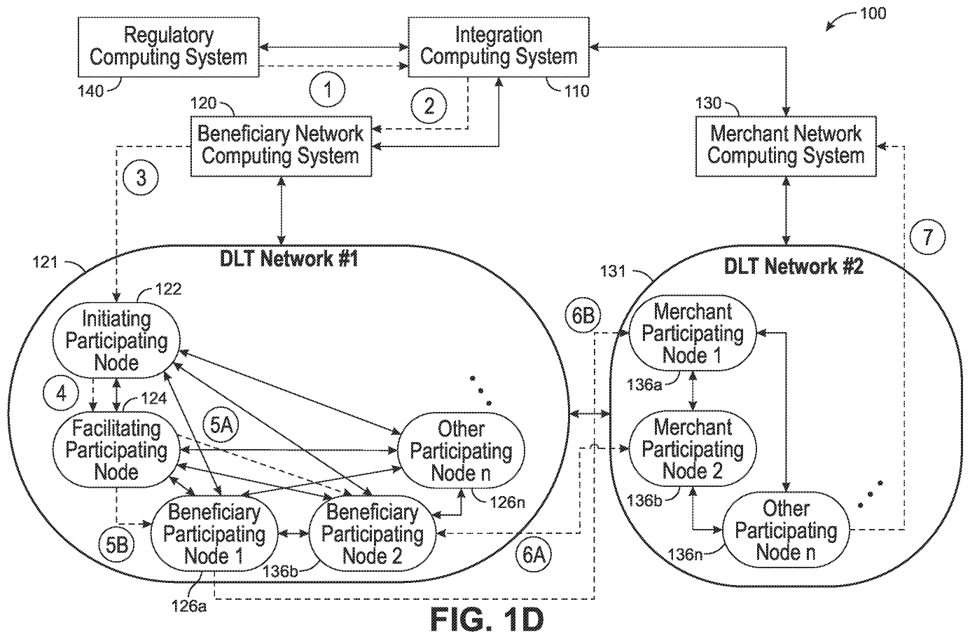

Referring now to FIG. 1A, a block diagram depicting an example of a proof of usage (PoU) architecture 100 is shown, according to some arrangements. The PoU architecture 100 is shown to include an integration computing system 110, a beneficiary network computing system 120, a DLT network 121, participating nodes 122-126, a merchant network computing system 130, merchant participating nodes 131-136, and a regulatory computing system 140. The plurality of devices and/or systems 110, 120, 130, and 140 may initiate, collect, and/or route (e.g., provide) data over a network.

Each of the computing systems and nodes described herein can include one or more processing circuits and memory. The one or more processing circuits can include a microprocessor, an application specific integrated circuit (ASIC), a field-programmable gate array (FPGA), and so on, or combinations thereof. A memory can include, but is not limited to, electronic, optical, magnetic, or any other storage or transmission device capable of providing processor with program instructions. Instructions can include code from any suitable computer programming language. It should also be understood that all communication between systems described herein can be either wireless or wired, depending on the network setup. Wireless communication might use protocols like Wi-Fi or Bluetooth, while wired communication could use Ethernet or fiber optic cables.

In some embodiments, the integration computing system 110 is configured to generate and manage DLT networks. To generate DLT network 121, integration computing system 110 can execute a series of instructions for initializing a distributed ledger. This can include allocating network resources (e.g., memory, processing power) and setting up network parameters like consensus protocols and cryptographic keys. Nodes 122, 124, and 126a-n are then instantiated, each running an instance of the ledger and maintaining its state. For DLT network 131, a similar process occurs. The integration computing system 110 creates another instance of a distributed ledger, configuring it separately to ensure independent operation from DLT network 121. This includes initializing a distinct set of network parameters and nodes.

The integration computing system 110 and the regulatory computing system 140 can access and exchange various data using data exchange protocols. In some embodiments, integration computing system 110 sends and receives data packets, using network protocols (e.g., TCP/IP) and data formats (e.g., JSON, XML). The integration computing system 110 parses incoming data to apply updates to policies or rules associated with disbursement schemes within the DLT networks.

In some embodiments, activating and connecting the beneficiary network computing system 120 to DLT network 121, and similarly the merchant network computing system 130 to DLT network 131, includes configuring network interfaces and protocols. The integration computing system 110 can set up the parameters (e.g., network addresses, security settings) and establish connections using networking protocols (e.g., HTTP, FTP) to enable communication with the nodes in the DLT networks. In some embodiments, the merchant network computing system 130 is independent and separate from the DLT network 131. In some embodiments, the merchant network computing system 130 is part of the DLT network 131 itself.

In some embodiments, the regulatory computing system 140, when communicating with integration computing system 110, uses data exchange formats and protocols. The regulatory computing system 140 can be a government computing system or data sources. The regulatory computing system 140 can provide (or provide access to) policies, rules, disbursements, schemes associated with disbursements, and updates to policies or rules (e.g., in real-time or near real-time) to the integration computing system 110.

Further to the capabilities of the regulatory computing system 140, it can also function as an administrative body or a corporate sector entity that either manages beneficiary accounts or is instrumental in creating and enforcing law. In examples involving government aid, the regulatory computing system 140 can act as the authoritative source for legislating and updating policies and rules associated with the aid disbursement. It ensures that the disbursement of funds aligns with the latest legal mandates or emergency directives, thereby maintaining compliance and relevance in rapidly changing socio-economic landscapes. In a corporate context, particularly in instances of corporate disbursements, the regulatory computing system 140 can manage the company's internal policies regarding fund distribution, ensuring that corporate governance standards are met and adhered to.

The proof of usage (PoU) architecture 100 can also include multiple DLT networks 121 and 131 that can execute smart contracts and perform exchanges with specific assets (e.g., funds or digital assets). The DLT networks can include a plurality of nodes that are interconnected with one another to form a peer-to-peer network. As shown in FIG. 1A, DLT network 121 includes nodes 122, 124, 126a, 126b, and 126n (collectively referred to herein as “DLT Network 190 1 nodes”) that are interconnected with one another to form the peer-to-peer network. Each of DLT Network #1 nodes on the distributed ledger network include hardware elements, one or more processors (e.g., any general purpose or special purpose processor), and/or be operably coupled to one or more transitory and/or non-transitory storage mediums and/or memory devices (e.g., any computer-readable storage media, such as a magnetic storage, optical storage, flash storage, RAM, and so on). DLT network 131 also includes nodes 136a, 136b, and 136n (collectively referred to herein as “DLT Network #2 nodes”) that are interconnected with one another to form the peer-to-peer network. Each of DLT Network #2 nodes on the distributed ledger network include hardware elements, one or more processors (e.g., any general purpose or special purpose processor), and/or be operably coupled to one or more transitory and/or non-transitory storage mediums and/or memory devices (e.g., any computer-readable storage media, such as a magnetic storage, optical storage, flash storage, RAM, and so on).

The beneficiary network computing system 120 (sometimes referred to herein as a “beneficiary discrete manager”) can be communicably coupled and operate the distributed ledgers nodes on the DLT network 121. That is, the beneficiary network computing system 120 has the role of initiating the issuing or disbursing of assets on the DLT network 121, and exchanging or destroying assets in response to a command. Assets can be digital representations of various different assets. For example, an asset could be a lending and/or trading document/contract, a financial exchange, a fiat currency, a payment card, a payment account, or any assets associated with services carried out by a financial institution. Further, each asset that is issued or disbursed on the DLT network 121 can include one or more protection parameters for the asset (e.g., funds or digital asset) based on a scheme. The scheme can correspond with a restriction or constraints on the usage of the asset.

In some embodiments, beneficiary network computing system 120 can be configured to provide issuance or disbursal of assets on the DLT network 121 and exchanges with DLT network 131. The assets managed by the beneficiary network computing system 120 can vary. Each asset issued or disbursed on the DLT network 121 may carry one or more protection parameters, reflective of specific constraints or restrictions tied to the asset's use according to various schemes (e.g., DBT schemes like PPP or Corona Relief Programs).

In some embodiments, the beneficiary network computing system 120, serving as a discrete manager within DLT network 121, is configured to validate transaction requests using a consensus model and a proof of usage model. The beneficiary network computing system 120 can work in conjunction with the participating nodes 122-126 to ensure transactions adhere to specific usage conditions. These conditions can be embedded within the network's smart contracts and may encompass category restrictions, geographical limitations, or temporal constraints on the funds or digital assets. The beneficiary network computing system 120, via its processing circuit, verifies that transactions meet these conditions before approval. In some embodiments, beneficiary network computing system 120 ensures compliance with the established usage conditions of the funds or digital assets. This includes an analysis of disbursement/exchange requests to determine their alignment with the stipulated usage rules.

Furthermore, in some embodiments, communication between the beneficiary network computing system 120 and the integration computing system 110 involves setting up operational parameters and establishing various communication channels. This includes configuring network settings and security measures for effective and secure data transfer. The system 120 interacts with nodes in DLT network 121, facilitating compliant and seamless transaction processing.

The initiating participating node 122 can be configured to initiate fund or digital asset disbursement exchanges. In some embodiments, the initiating participating node 122 acts as the starting point for disbursement, initiating the chain of events that lead to disbursement. In general, the initiating participating node 122 can trigger smart contracts that govern the flow of assets within DLT network 121, ensuring that all exchanges (e.g., disbursements, issuance, transactions) adhere to the established rules and protection parameters of the DLT network 121.

The facilitating participating node 124 can be configured to execute one or more smart contracts corresponding with the fund or digital asset disbursement and append the exchange to include the protection parameter based on the scheme. In some embodiments, the facilitating participating node 124 execution includes appending the transaction to include a protection parameter based on the scheme associated with the disbursement. The facilitating node participating node 124, linked to a financial entity or institution, ensures that the disbursement follows the stipulated guidelines and carries the correct protection parameters.

The plurality of beneficiary participating nodes 126a-n can be configured to receive and authorize an exchange of at least the portion of the funds or digital asset in accordance with the protection parameter. The beneficiary participating nodes 126a-n can verify and accept exchanges, ensuring each exchange on the DLT network 121 and between DLT networks aligns with the stipulated usage criteria and protection parameters.

In some embodiments, the merchant network computing system 130, as a discrete manager within DLT network 131, is configured to validate transaction requests using a consensus model alongside a proof of usage model. This includes the merchant network computing system 130 collaborating with merchant participating nodes 136a-n to confirm the adherence of exchanges to specific usage conditions. These conditions, encoded within the network's smart contracts, might include category restrictions, geographical limitations, or temporal constraints on the funds or digital assets being transacted. The merchant network computing system 130, through its processing circuit, ensures that transactions comply with these stipulated conditions before they are authorized.

In the context of proof of usage, the merchant network computing system 130 and the merchant participating nodes 136a-n can use context packets to verify the appropriateness of transactions. These packets contain digitally encoded metadata that outlines authorized expenditures under specific schemes. For each transaction, the merchant network computing system 130 checks against these context packets to ensure the expenditure aligns with an authorized list of goods or services, which are tailored to each merchant within DLT network 131.

Additionally, in some embodiments, the communication between the merchant network computing system 130 and the integration computing system 110 involves initializing operational parameters and establishing multiple communication channels. This includes setting up network configurations and security protocols for reliable and secure data exchange. The merchant network computing system 130 can communicate with nodes in both DLT networks (e.g., 121 and 131). In some embodiments, both the beneficiary network computing system 120 and the merchant network computing system 130 require adherence to their respective proof of usage models to approve a disbursement or exchange.

For the beneficiary network computing system 120 on DLT network 121, the approval of disbursements can be contingent upon the compliance with smart contracts that enforce usage conditions of the protection parameters. These conditions could include, for example, restrictions on the type of transactions a beneficiary can initiate, such as allowing disbursements only for certain categories of goods or services, within specific geographical areas, or during particular time frames. The beneficiary network computing system 120 can analyze each transaction request against these smart contract conditions before approving any fund or asset transfers.

Similarly, the merchant network computing system 130 on DLT network 131 also applies a proof of usage model to confirm transactions adhere to authorized expenditures. This includes using context packets that contain encoded metadata specifying authorized goods or services for each merchant. Before approving a transaction, the merchant network computing system 130 executes smart contracts enforcing the protection parameters and checks the request against these context packets to ensure it falls within the allowed range of expenditures.

An example of a disbursement occurring under these conditions would be a transaction from a bank, represented as beneficiary participating node 126b on DLT network 121, to a supermarket, represented as merchant participating node 136b on DLT network 131. In this example, a customer at the bank might want to purchase groceries using funds received under a specific DBT scheme. First, using a proof of usage model, the transaction request is evaluated by the beneficiary network computing system 120 against the smart contracts in DLT network 121. These contracts check if the disbursement aligns with the protection parameters, such as being for permissible categories of expenditure. Upon approval by beneficiary network computing system 120, the request is then communicated to DLT network 131, where the merchant network computing system 130 assesses it against its proof of usage model. Here, the merchant network computing system 130 refers to context packets corresponding to the supermarket (merchant participating node 136b) to verify if the purchase of groceries is an authorized expenditure under the scheme. If the transaction meets all these criteria and the protection parameter, it is authorized (i.e., processed successfully).

Referring now to FIG. 1B, a block diagram depicting an example of another PoU architecture 150, according to some arrangements. The PoU architecture 150 includes similar features and functionality as described above with reference to PoU architecture 150 of FIG. 1A. However, as shown, the DLT networks 121 and 131 can include the regulatory computing system 140 that can be interconnected with the distributed ledger nodes to form a peer-to-peer network (e.g., DLT network 121 and 131). Indeed, since the regulatory computing system 140 is on the DLT network, the regulatory computing system 140 can issue disbursements and schemes (e.g., policies, rules, laws) directly to the nodes on the DLT network. In some embodiments, the network computing systems 120 and 130 can initiate the disbursements and schemes (e.g., with disbursements or updates to schemes). In some embodiments, the direct involvement of the regulatory computing system 140 in the DLT networks enhances the speed and accuracy of policy implementation and fund distribution. For instance, in situations requiring immediate financial aid or rapid policy changes (e.g., during natural disasters or economic crises), the regulatory system 140 can quickly disseminate funds or update rules directly across the DLT network without intermediary delays. Additionally, in some embodiments, this PoU architecture 150 provides improved transparency and traceability in transactions. Since the regulatory computing system 140 is a node within the DLT networks, it can monitor transactions in real-time, ensuring compliance with the latest regulations and detecting any anomalies or fraudulent activities (e.g., misuse of funds, non-compliance with scheme conditions). This direct oversight by the regulatory computing system 140, in combination with the network computing systems 120 and 130, may lead to enhanced trust and reliability in the network's operations, making it a suitable choice for managing sensitive or critical disbursement schemes. In some arrangements, the regulatory computing system 140 and nodes can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

Referring now to FIG. 1C, a block diagram depicting an example of another PoU architecture 160, according to some arrangements. The PoU architecture 160 includes similar features and functionality as described above with reference to PoU architecture 150 of FIG. 1A. However, as shown, the DLT networks 121 and 131 can include the regulatory computing system 140 and the network computing systems 120 and 130 that can be interconnected with their respective distributed ledger nodes to form a peer-to-peer network (e.g., DLT network 121 and 131). Indeed, since the regulatory computing system 140 is on both DLT networks (e.g., 121 and 131), the beneficiary network computing system 120 is on DLT network 121, and the merchant network computing system 130 is on DLT network 131, this architecture provides direct regulatory control and streamlined transaction processing. The presence of the regulatory computing system 140 in both DLT networks (e.g., 121 and 131) provides a unified regulatory framework directly within the transactional environment. This means that regulatory updates, policy changes, or disbursement instructions can be implemented and propagated across both networks instantaneously and uniformly. For example, in scenarios demanding quick adaptation to legal or economic changes (e.g., emergency economic measures, sudden regulatory shifts), the PoU architecture 160 allows for swift, network-wide updates without the need for intermediate layers or external communication channels.

Moreover, in some embodiments, the direct incorporation of the beneficiary and merchant network computing systems (120 and 130) within their respective DLT networks enhances transaction efficiency and accuracy. This configuration reduces the latency typically associated with external system communications, leading to faster transaction validations and approvals. Specifically, in operations requiring high-frequency transactions or real-time financial data processing (e.g., high-volume retail environments, rapid aid disbursement scenarios), the minimized communication delay can significantly enhance operational efficiency. Additionally, the integrated design of architecture 160 enables a more streamlined data flow and reduces potential points of failure or security vulnerabilities that might arise in a more segmented network structure. For example, in applications involving sensitive financial data or where security and data integrity are important (e.g., handling of government funds, transactions in highly regulated markets), this architecture may offer an added layer of security by maintaining critical components within the DLT networks, thereby reducing exposure to external threats. In some arrangements, the regulatory computing system 140, the network computing systems 120 and 130, and nodes can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

Referring to FIGS. 1A-1C collectively, in evaluating the PoU architectures 100, 150, and 160, it should be understood that each is designed with distinct advantages, tailored to specific operational contexts, rather than implying a hierarchy of superiority. Architecture 100 may be optimal for environments favoring traditional DLT network management, with a clear demarcation between regulatory and operational elements. Architecture 150 advances this by integrating the regulatory computing system within the DLT networks, offering enhanced responsiveness to policy changes, suitable for scenarios requiring rapid regulatory adaptations. Further, architecture 160 provides an integration of both regulatory and network computing systems within the DLT networks, ideal for contexts demanding high transactional efficiency and close regulatory oversight.

Referring now to FIG. 1D, a block diagram depicting an example of the PoU architecture 100 of FIG. 1A including a PoU process, according to some arrangements. Prior to step 1, DLT network 121 (i.e., DLT network #1) is created having an initiating participating node 122, a facilitating participating node 124 (e.g., any financial institution), and one or more beneficiary participating nodes 126a-b, and one or more other participating nodes 126n. Additionally, DLT network 131 (i.e., DLT network #2) is created having one or more merchant participating nodes 136a-b and one or more other participating nodes 136n. In some embodiments, a discrete manager is configured to process communications and exchanges between, and internal to, the DLT networks 121 and 131 and external systems at an entry of each of the DLT networks 121 and 131. For example, DLT network 121 has a beneficiary computing system 120 and DLT network 131 has a merchant computing system 130. Further, each of the network computing systems can be connected to a single central entity, shown as integration computing system 110.

At step 1 of the flow, the integration computing system 110 can receive an instruction from the regulatory computing system 140 to transfer funds to one or more beneficiaries under a DBT scheme (e.g., Paycheck Protection Program (PPP), Corona Relief Program). In some embodiments, the instruction can include detailed parameters regarding the amount, timing, and eligible recipients of the funds. For example, the instructions may specify eligibility criteria for beneficiaries or conditions under which the funds can be used.

At step 2 of the flow, the integration computing system 110 forwards or passes the instructions to the beneficiary network computing system 120. In some embodiments, this can include encoding the instructions into a format compatible with the DLT network protocols. Specifically, the process may involve converting regulatory directives into smart contracts or digital commands that can be interpreted by DLT network 121. For example, instructions may be translated into transaction requests or digital tokens that represent the funds to be disbursed.

At step 3 of the flow, the beneficiary network computing system 120 then initiate a disbursement with the DLT network 121 by communicating the instructions to the initiating participating node 122. In some embodiments, this can include generating a transaction within DLT network 121 that encapsulates the instructions. Specifically, the system may create a digital representation of the funds transfer, embedding the necessary metadata such as recipient details and fund amounts. For example, the beneficiary network computing system 120 might issue a transaction that triggers a smart contract execution for a disbursement process.

At step 4 of the flow, the initiating participating node 122 can communicate the instructions to the facilitating participating node 124. Further, a smart contract is executed between the initiating participating node 122 and the facilitating participating node 124 on how to disburse the funds to the one or more beneficiaries and also a type of protection parameter (e.g., flag, based on the DBT scheme) to be attached when sending or exchanging the funds (or other digital assets). In some embodiments, this can include scripting the conditions of the fund transfer within the smart contract. Specifically, the contract may detail the criteria under which the funds are to be released, aligned with the DBT scheme's guidelines. For example, the contract could include mechanisms to ensure the funds are only used for specific types of expenditures, like essential goods or services, as defined by the DBT scheme.

At step 5a and 5b of the flow, the facilitating participating node 124 disburses the funds by attaching the protection parameter (e.g., PPP flag) when transferring the funds to the one or more beneficiary participating nodes 126a and 126b. In some embodiments, this can include executing smart contracts that encode the specific protection parameters onto the transaction. Specifically, these contracts automatically ensure that the disbursed funds adhere to the set usage conditions, such as category, geographical, or temporal restrictions, as per the DBT scheme. For example, the smart contracts executed by the facilitating participating node 124 could be programmed to automatically verify that the funds being transferred to the beneficiary participating nodes 126a and 126b are to be used for purposes that align with the DBT scheme, like the Paycheck Protection Program (PPP). These contracts might check that the funds are being used in the correct geographical area, within a specified time frame, and for specific categories of goods or services as delineated by the PPP guidelines.

At step 6a and 6b of the flow, when the beneficiary participating nodes 126a and 126b attempts to transfer the funds (e.g., in response to receiving an exchange request from a merchant participating node on DLT network 131) to merchant participating node 136a (e.g., supermarket entity) for a soap purchase, one or more participating nodes in DLT network 131 retrieve the scheme associated with the beneficiary participating node 136a to use the funds and an allowed list of values (e.g., authorized list of goods or services, or identifiers or values corresponding with the authorized list of goods or services) that can be purchased from the merchant network computing system 130. In some embodiments, an attempt to transfer funds from DLT network 121 to DLT network 131 can be in response to a validated transaction request, where the validation process includes verifying the adherence of the transaction to the encoded protection parameters. Specifically, this process can include smart contract mechanisms that automatically check if the fund's usage aligns with the set conditions, such as the type of goods or services allowed under the scheme. For example, the smart contracts might assess whether the soap purchase by beneficiary nodes 126a and 126b from merchant node 136a falls within the permissible categories of expenditure as defined by the PPP scheme or other similar programs. When an exchange of funds occurs, it can include the execution of these smart contracts, which are designed to cross-reference the transaction details against the allowed list of values provided by the merchant network computing system 130. Specifically, the merchant participating node 136a can ensure that the transaction for the soap purchase conforms to the predefined criteria set within the smart contracts. For example, a transaction might be processed only if it passes the protection parameter and it matches the identifiers or values that correspond with authorized goods, such as essential commodities, in this case soap, as per the scheme's guidelines.

At step 7 of the flow, the one or more participating nodes (e.g., participating node 136n) in DLT network 131 can provide their consensus by checking with the merchant network computing system 130 as the soap purchase is included in the allowed list of values, and the transaction is processed successfully (i.e., authorized). In some embodiments, a new block on DLT network 131 is created to record this transaction, embedding the consensus decision and adherence to the protection parameter. This process can include the collaborative verification of the transaction's compliance with the smart contract conditions, ensuring it aligns with the encoded authorized expenditures in the context packets. For example, the creation of the new block on DLT network 131 would include recording the details of the soap purchase transaction, including the results of the consensus process. The block would encapsulate data such as the transaction amount, the identities of the participating nodes involved, and the outcome of the smart contract verification.

Additionally, throughout steps 5-7, in addition to executing the proof of usage model, the DLT networks can simultaneously engage in a consensus model, such as proof of work or proof of stake, which operates independently yet in parallel. This consensus model can validate and record transactions across the network. For example, while the proof of usage model ensures compliance with specific usage conditions and authorized expenditures, the consensus model (e.g., proof of work or proof of stake) is responsible for maintaining the overall integrity and security of the blockchain. In this model, participating nodes, such as nodes 126a-b and 136n, contribute to the validation of transactions and the creation of new blocks. Specifically, the separation of these models allows for an improved, secure handling of transactions, ensuring both adherence to regulatory requirements and the maintenance of a reliable and tamper-proof record of all activities within the DLT networks.

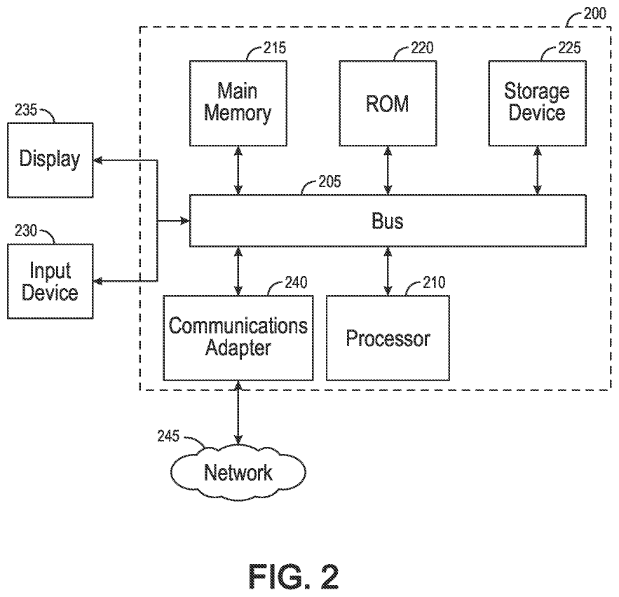

Referring now to FIG. 2, a depiction of a computer system 200 is shown. The computer system 200 that can be used, for example, to implement a computing environment (e.g., PoU architecture 100), the integration computing system 110, the beneficiary networking computing system 120, the merchant network computing system 130, the regulatory computing system 140, the nodes of the DLT networks 121 and 131, and/or various other example systems described in the present disclosure. The computing system 200 includes a bus 205 or other communication component for communicating information and a processor 210 coupled to the bus 205 for processing information. The computing system 200 also includes main memory 215, such as a random-access memory (RAM) or other dynamic storage device, coupled to the bus 205 for storing information, and instructions to be executed by the processor 210. Main memory 215 can also be used for storing position information, temporary variables, or other intermediate information during execution of instructions by the processor 210. The computing system 200 may further include a read only memory (ROM) 220 or other static storage device coupled to the bus 205 for storing static information and instructions for the processor 210. A storage device 225, such as a solid-state device, magnetic disk or optical disk, is coupled to the bus 205 for persistently storing information and instructions.

The computing system 200 may be coupled via the bus 205 to a display 235, such as a liquid crystal display, or active matrix display, for displaying information to a user. An input device 230, such as a keyboard including alphanumeric and other keys, may be coupled to the bus 205 for communicating information, and command selections to the processor 210. In another arrangement, the input device 230 has a touch screen display 235. The input device 230 can include any type of biometric sensor, a cursor control, such as a mouse, a trackball, or cursor direction keys, for communicating direction information and command selections to the processor 210 and for controlling cursor movement on the display 235.

In some arrangements, the computing system 200 may include a communications adapter 240, such as a networking adapter. Communications adapter 240 may be coupled to bus 205 and may be configured to enable communications with a computing or communications network and/or other computing systems. In various illustrative arrangements, any type of networking configuration may be achieved using communications adapter 240, such as wired (e.g., via Ethernet), wireless (e.g., via Wi-Fi, Bluetooth), satellite (e.g., via GPS) pre-configured, ad-hoc, LAN, WAN.

According to various arrangements, the processes that effectuate illustrative arrangements that are described herein can be achieved by the computing system 200 in response to the processor 210 executing an arrangement of instructions contained in main memory 215. Such instructions can be read into main memory 215 from another computer-readable medium, such as the storage device 225. Execution of the arrangement of instructions contained in main memory 215 causes the computing system 200 to perform the illustrative processes described herein. One or more processors in a multi-processing arrangement may also be employed to execute the instructions contained in main memory 215. In alternative arrangements, hard-wired circuitry may be used in place of or in combination with software instructions to implement illustrative arrangements. Thus, arrangements are not limited to any specific combination of hardware circuitry and software.

That is, although an example processing system has been described in FIG. 2, arrangements of the subject matter and the functional operations described in this specification can be carried out using other types of digital electronic circuitry, or in computer software (e.g., application, blockchain, distributed ledger technology) embodied on a tangible medium, firmware, or hardware, including the structures disclosed in this specification and their structural equivalents, or in combinations of one or more of them. Arrangements of the subject matter described in this specification can be implemented as one or more computer programs, e.g., one or more subsystems of computer program instructions, encoded on one or more computer storage medium for execution by, or to control the operation of, data processing apparatus. Alternatively, or in addition, the program instructions can be encoded on an artificially generated propagated signal, e.g., a machine generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

Although shown in the arrangements of FIG. 2 as singular, stand-alone devices, one of ordinary skill in the art will appreciate that, in some arrangements, the computing system 200 may include virtualized systems and/or system resources. For example, in some arrangements, the computing system 200 may be a virtual switch, virtual router, virtual host, virtual server. In various arrangements, computing system 200 may share physical storage, hardware, and other resources with other virtual machines. In some arrangements, virtual resources of the network may include cloud computing resources such that a virtual resource may rely on distributed processing across more than one physical processor, distributed memory, etc.

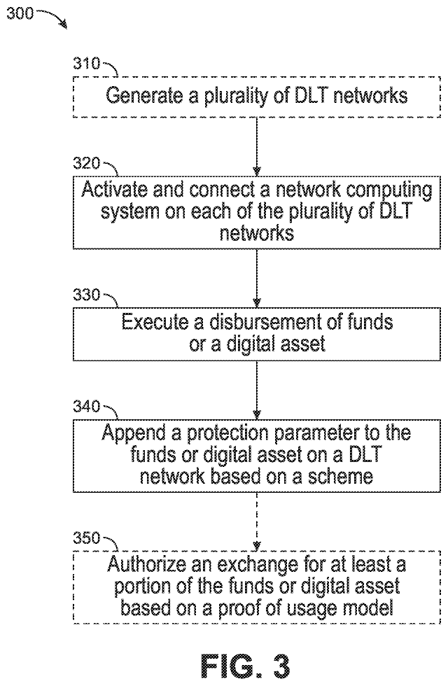

Referring now to FIG. 3, a flowchart for a method 300 of authorizing exchanges using a PoU model is shown, according to some embodiments. The computing systems and nodes of FIG. 1 can be configured to perform method 300. Further, any computing device described herein can be configured to perform method 300.

In broad overview of method 300, at block 310, the one or more processing circuits can generate a plurality of DLT networks. At block 320, the one or more processing circuits can activate and connect a network computing system on each of the plurality of DLT networks. At block 330, the one or more processing circuits can execute a disbursement of funds or digital asset. At block 340, the one or more processing circuits can append a protection parameter to the funds or digital asset on a DLT network based on a scheme. At block 350, the one or more processing circuits can authorize an exchange for at least a portion of the funds or digital asset based on a proof of usage model. Additional, fewer, or different operations may be performed depending on the particular arrangement. In some arrangements blocks can be optionally executed (e.g., blocks depicted as dotted lined) by the one or more processors. Additional, fewer, or different operations may be performed depending on the particular arrangement. In some embodiments, some, or all operations of method 300 may be performed by one or more processors executing on one or more computing devices, systems, or servers. In various embodiments, each operation may be re-ordered, added, removed, or repeated.

In general, method 300 includes generating two distinct Distributed Ledger Technology (DLT) networks. The generation can establish a first DLT network that includes various nodes such as a transaction initiating node, a facilitating node (associated with a financial institution), a beneficiary node, and consensus nodes. The second DLT network can be configured for merchants, with each merchant node and consensus nodes operating within the second DLT network. In some embodiments, each DLT network can have a discrete manager at its entry point. For example a beneficiary discrete manager can be used for the first DLT network and a merchant discrete manager can be used for the second DLT network (i.e., beneficiary network computing system 120 and merchant network computing system 130 of FIGS. 1A-D). The discrete managers can be connected to a central consortium-managed discreteness manager (i.e., integration computing system 110 of FIGS. 1A-D). Furthermore, the consortium-managed discreteness manager can receive instructions from a regulatory or government authority to transfer funds to beneficiaries under various schemes (e.g., Direct Benefit Transfer (DBT) scheme). Moreover, instructions from the consortium-managed discreteness manager are provided to the beneficiary discrete manager, then to the initiating participating node, and finally to the facilitating participating node. In some embodiments, a smart contract can dictate the disbursement of funds to the beneficiaries, and one or more specific protection parameters (e.g., flags) can be attached to these transactions.

Additionally, funds or digital assets can be disbursed from the facilitating participating node to the beneficiary participating nodes. The disbursed funds can include a protection parameter as stipulated by the smart contract. In some embodiments, when a beneficiary participating node (e.g., a bank) wishes to use the funds to make a purchase from a merchant (e.g., buying soap), the transaction request is initiated on the first DLT network. The transaction request can be communicated to the consortium-managed discreteness manager, which acts as a bridge between first and second DLT network. In some embodiments, the consortium-managed discreteness manager can relay this request to the merchant discrete manager on the second DLT network. The merchant discrete manager, along with other participating nodes on the second DLT network, can check if the requested transaction (e.g., soap purchase) aligns with the allowed list of values and schemes associated with the beneficiary node's funds (i.e., conditions encoded within context packets). If the purchase is within the allowed parameters, the participating nodes on the second DLT network reach a consensus, thereby validating the transaction. Additionally, a consensus mechanism (e.g., proof of stake, proof of work) can also be performed on both the first and second DLT networks to authorize the transaction. Once the transaction is approved, the fund transfer from the beneficiary participating node to the merchant participating node is executed, completing the purchase.

Referring now to method 300 in greater detail, at block 310, the one or more processing circuits can generate a plurality of distributed ledger technology (DLT) networks. In some embodiments, a first DLT network of the plurality of DLT networks includes an initiating participating node, a facilitating participating node, and a plurality of beneficiary participating nodes. The initiating participating node can be configured to initiate fund or digital asset disbursement exchanges. The facilitating participating node can be configured to execute one or more smart contracts corresponding with the fund or digital asset disbursement and append the exchange to include the protection parameter based on the scheme. The plurality of beneficiary participating nodes can be configured to receive and authorize the exchange of at least the portion of the funds or digital asset in accordance with the protection parameter. In some embodiments, a second DLT network of the plurality of DLT networks includes a plurality of merchant participating nodes. The plurality of merchant participating nodes can be configured to authorize the exchange based on the proof of usage model provided by the second network computing system and execute, using the consensus model, consensus decision-making for exchange authorization or rejection.

Specifically, in the generation of these DLT networks, the processing circuits deploy distinct configurations for each network to fulfill their respective roles. In some embodiments, the first DLT network, with its initiating participating node, is responsible for the initiation of fund or digital asset disbursement exchanges. This initiation involves preparing and sending transaction requests, which are then received and processed by the facilitating participating node. For example, the facilitating participating node executes smart contracts that initiate and perform the disbursement process. These smart contracts, designed to align with specific schemes (e.g., DBT), automate the disbursement process and enforce compliance with the scheme's parameters (e.g., fund allocation, beneficiary eligibility). Additionally, the facilitating participating node appends each exchange with a protection parameter, like flags or markers, which signify adherence to the prescribed usage conditions. The beneficiary participating nodes, meanwhile, are equipped to receive these exchanges and have the capability to authorize them based on the set protection parameters. This authorization process can include verification steps to ensure that the exchange aligns with the rules encoded in the protection parameter (e.g., checking against category or geographical restrictions, among other restrictions).

For example, in the second DLT network, including a variety of merchant participating nodes, the authorization of exchanges is contingent upon the proof of usage model provided by the network computing system. This model ensures that all transactions are consistent with the intended use of the funds or digital assets. In some embodiments, these merchant participating nodes employ a consensus model for decision-making, which allows for collective agreement on the authorization or rejection of exchanges. Specifically, the consensus model may include various mechanisms (e.g., Proof of Work, Proof of Stake) to achieve agreement among the nodes. The merchant participating nodes, upon receiving an exchange request or communication (e.g., from the first DLT network), validate it against the proof of usage model, which may include executing the protection parameters encoded in smart contracts and checking the transaction against context packets containing authorized expenditures. If the transaction aligns with the allowed expenditures and meets other criteria set by the proof of usage model (e.g., temporal and category-specific allowances), the consensus mechanism is employed to authorize the exchange. In some embodiments, the consensus mechanism is executed prior to the proof of usage model. Conversely, if the transaction does not comply with the conditions of the proof of usage model, it is subject to rejection, thereby preventing unauthorized or inappropriate usage of funds or digital assets within the DLT network.

In some embodiments, the generation of a DLT network includes the establishment of network infrastructure and protocols that define the operational rules and interactions among different nodes within each network. For example, the processing circuits initially can configure network parameters such as node permissions, consensus algorithms, and communication protocols. In some embodiments, the generation of a DLT network starts with the deployment of a blockchain or similar ledger technology, where each node in the network is assigned a unique identifier and specific roles (e.g., initiating, facilitating, beneficiary, merchant nodes). The processing circuits then implement smart contract functionality within the network, enabling automated execution of predefined rules and transactions. These smart contracts can govern the interaction between nodes and ensure adherence to the network's designated purpose, such as fund disbursement or transaction validation. Additionally, the network's security protocols are established, including the implementation of encryption mechanisms (e.g., public and private key pairs) to secure transactions and data exchanges. In some embodiments, the processing circuits also configure the network to support the integration of protection parameters and context packets, which are essential for enforcing the proof of usage model and authorized expenditures within the network.

At block 320, the one or more processing circuits can activate and connect a first network computing system to at least one of the DLT networks and activate and connect a second network computing system to at least one of the DLT networks. In some embodiments, a first DLT network of the plurality of DLT networks corresponds with the first network computing system and a second DLT network of the plurality of DLT networks corresponds with the second network computing system. In some embodiments, the first network computing system and the second network computing system are external to the plurality of DLT networks, and wherein activating and connecting includes initializing operational parameters of the first network computing system and the second network computing system and establishing a plurality of communication channels with participating nodes within the first DLT network and the second DLT network.

Specifically, the activation of the first and second network computing systems can include a series of steps performed by the processing circuits. In some embodiments, the activation includes the initialization of operational parameters for each network computing system, which sets up the configurations necessary for their functioning. For example, these operational parameters might encompass network interface settings, data processing capabilities, security protocols (e.g., encryption standards), and resource allocation (e.g., memory and processing power distribution). Once initialized, the processing circuits proceed to connect these network computing systems to their respective DLT networks. Specifically, the process of connecting can include establishing a plurality of communication channels. These channels can be configured to support various types of data exchanges, such as transaction requests, consensus information, and smart contract executions.

In some embodiments, the process of activating and connecting the network computing systems to the DLT networks also includes synchronizing with the ledger states of the respective networks. For example, the first network computing system, upon activation, might synchronize its internal ledger with that of the first DLT network to ensure that it has the latest transaction records and network status. Additionally, the network computing systems can be equipped with mechanisms to manage and interpret data from smart contracts deployed within the DLT networks. This includes parsing and executing smart contract clauses (e.g., conditions for transaction validation, rules for fund disbursement) and ensuring compliance with the network's operational rules. Moreover, these network computing systems can handle network-specific tasks, such as managing the proof of usage models and protection parameters for transactions within their respective networks. In some embodiments, this includes analyzing transaction data against the encoded usage conditions and authorized expenditures, and making decisions (e.g., approval or rejection) based on this analysis. The connection established between the network computing systems and the DLT networks, therefore, facilitates communication and enables the network computing systems to perform network management and oversight functions, enhancing the security and functionality of the DLT networks.

At block 330, the one or more processing circuits can execute a disbursement of funds or digital asset corresponding with the first network computing system. In some embodiments, the processing circuits can receive a disbursement request based on a scheme from a regulatory computing system. Accordingly, the disbursement corresponding with funds or digital asset can be based on receiving the disbursement request. Specifically, when executing the disbursement of funds or digital assets as directed by a regulatory entity or corporation, the processing circuits can transfer these funds directly to banks (or another provider system, such as a retirement or investment entity, an employer, etc.), which act as intermediary facilitators. In some embodiments, these financial institutions receive the funds along with a data structure that includes the scheme and authorized expenditure parameters set by the regulatory entity. This data structure outlines how the funds can be used, detailing conditions and limitations per the scheme's guidelines. For example, the funds might be allocated for specific welfare programs, with restrictions on their use for certain categories of expenses. The bank (i.e., node of the first DLT network), upon receiving the funds, is responsible for managing and disbursing them in accordance with these predefined conditions. However, at this stage, the funds are disbursed without yet having the protection parameters or flags attached.

In these embodiments, the processing circuits facilitates the accurate and secure transfer of funds to the banks. This can include initiating transactions on the first DLT network that reflect the disbursement from the regulatory body to the respective banks. For example, when a government disburses relief funds, the processing circuits update the ledger entries on the first DLT network to record the transfer of funds from the government to the designated bank's node. Following the initial transfer, the banks then can append the protection parameters to the funds before allowing any disbursement (e.g., to a merchant). In some embodiments, these protection parameters align with the conditions and restrictions specified in the data structure accompanying the funds. For example, the processing circuits may add flags to the funds that dictate their usage for specific purposes only, such as healthcare expenses or educational fees, in line with the regulatory scheme's guidelines.

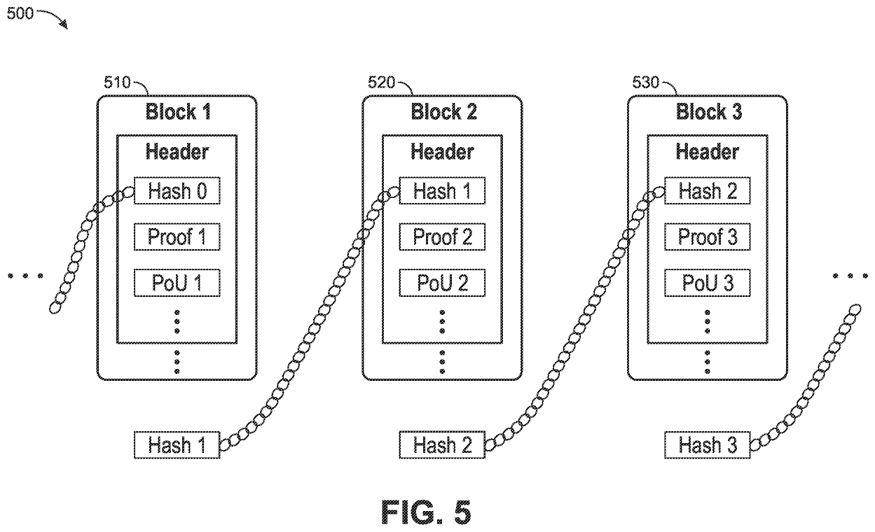

At block 340, the one or more processing circuits can append a protection parameter to the funds or digital asset on at least one of the DLT networks based on a scheme, the scheme corresponding to restrictions on one or more usages of the funds or digital asset. In some embodiments, the protection parameter corresponds to executable code added to the exchange on the plurality of DLT networks by the processing circuits to restrict or authorize a future exchange. In some embodiments, the processing circuits can store, on a ledger of the first DLT network, the funds or digital asset. In some embodiments, the one or more smart contracts can enforce one or more usage conditions of the protection parameter on the first DLT network or when an exchange occurs between the first DLT network and the second DLT network with the corresponding funds or digital asset. For example, the one or more usage conditions can include at least one of a category restriction on the funds or digital asset, a geographical restriction on the funds or digital asset, a temporal restriction on the funds or digital asset. With reference to FIG. 5, a new blockchain block can be created on the first DLT network with one or more smart contracts deployed in the header (e.g., “proof of usage (PoU) 1” block in Block 510 of FIG. 5) of the block encoded with the protection parameters. In some embodiments, a blockchain block may have already been created in step 330 and instead updated with the PoU block.

In some embodiments, this protection parameter is implemented as executable code that is integrated into the transaction or exchange record on the DLT network. This code functions to enforce restrictions or authorize future exchanges based on the scheme's guidelines, such as category, geographical, or temporal restrictions on the use of the funds. For example, in a scenario where funds are allocated for educational purposes, the executable code would restrict the use of these funds to educational expenses only. The process of appending this parameter includes modifying the transaction data within the network's ledger, ensuring that each transaction associated with these funds adheres to the specified usage conditions.

In some embodiments, the processing circuits can create or update a blockchain block to encapsulate the funds or digital asset with the appended protection parameters. This can include either generating a new block in the blockchain or updating an existing block, depending on the stage of the transaction (i.e., disbursement initiated by a regulatory computing system) in the DLT network. For example, if a disbursement transaction has already been recorded in an existing block (as might have occurred in step/block 330), the processing circuits update this block to include the protection parameters. This update can be achieved by embedding the smart contracts, which contain the executable code for the protection parameters, into the header of the block. Generally, the header acts as a summary and includes essential information about the block's contents, including these smart contracts. For example, in the “proof of usage (PoU) 1” block, as shown in Block 510 of FIG. 5, the header is encoded with the protection parameters, ensuring that any transaction contained within the block is subject to the enforced usage conditions.

Furthermore, in some embodiments, the process of creating or updating a block with the protection parameters includes synchronization and validation within the DLT network. The processing circuits can coordinate with various nodes within the DLT network to achieve consensus on the validity of the block and its contents. For example, participating nodes might independently verify the appended protection parameters against the scheme's criteria using consensus mechanisms such as Proof of Work or Proof of Stake. Once consensus is reached, the block, now encoded with the protection parameters, is validated and added to the blockchain or updated in the existing blockchain.

At block 350, the one or more processing circuits can, in response to receiving an exchange request from the second network computing system, authorize an exchange for at least a portion of the funds or digital asset based on at least a consensus model and a proof of usage model on at least two of the plurality of DLT networks, wherein the proof of usage model authorization occurs by at least one of the first network computing system or the second network computing system. In particular, the authorization can be performed on two DLT networks. For example, the first DLT network can, in response to receiving an exchange request for an exchange from at least one of the plurality of merchant participating nodes, authorize the exchange for at least a portion of the funds or digital asset on the first DLT network based on at least a first consensus model and a proof of usage model. In this example, the second DLT network can, in response to receiving an indication of authorization of the exchange on the first DLT network, authorize the exchange on the second DLT network for at least the portion of the funds or digital asset based on at least a second consensus model and the proof of usage model. In some embodiments, the proof of usage model, implemented by the processing circuits, includes confirming a usage of at least the portion of the funds or digital asset based on complying with one or more smart contracts enforcing one or more usage conditions of the protection parameter on the first DLT network, for example, in order to maintain discreteness (e.g., a discrete flag, a discrete parameter, etc.). Specifically, the one or more usage conditions include at least one of a category restriction on the funds or digital asset, a geographical restriction on the funds or digital asset, a temporal restriction on the funds or digital asset. Additionally, the proof of usage model includes adhering to one or more authorized expenditures encoded within context packets on the second DLT network.

In some embodiments, when a merchant participating node submits an exchange request to the first DLT network, it includes specific details of the transaction that are crucial for executing the proof of usage model. Specifically, this exchange request includes information such as the type and amount of goods or services involved, the intended use of the funds or digital assets, and any relevant transaction identifiers. This data can allow both the first and second DLT networks to execute the proof of usage model, which can stored in the header of previously created blocks of the blockchain associated with the funds or digital assets in question. For example, a merchant node requesting to complete a transaction for educational materials would provide details like the nature of the materials, their cost, and the transaction ID. The processing circuits within the DLT networks then use this information to reference the proof of usage model in the blockchain's block header. This model can include pre-set conditions and authorized expenditures relevant to the funds or digital assets, ensuring that the transaction adheres to the stipulated usage guidelines.

In some embodiments, when authorizing an exchange on the first DLT network in response to an exchange request, the processing circuits engages in a multi-faceted verification process. Specifically, the first step involves validating the exchange request against the first consensus model of the network. This model might include various consensus mechanisms such as Proof of Work or Proof of Stake, through which the participating nodes in the first DLT network agree on the legitimacy of the transaction. For example, this could involve verifying the transaction's alignment with the network's ledger history and rules. Following this, the processing circuits apply the proof of usage model to the transaction. This model confirms that the use of the funds or digital asset aligns with the defined usage conditions, such as category, geographical, or temporal restrictions. The enforcement of these conditions is typically achieved through smart contracts embedded in the first DLT network. These smart contracts autonomously verify that the transaction adheres to the conditions, such as ensuring funds are used only for educational purposes if that is the specified category restriction.

Similarly, on the second DLT network, the authorization process of an exchange involves its own unique steps and mechanisms, particularly following the receipt of authorization confirmation from the first DLT network. In some embodiments, the second network's processing circuits first receive confirmation of the transaction's approval from the first DLT network. This confirmation initiates a subsequent validation process using the second DLT network's consensus model. The participating nodes of this network independently validate the transaction, ensuring it is in alignment with the second network's operational rules and ledger history. Following this consensus validation, the processing circuits implement the proof of usage model, which is specific to the second DLT network. This model includes re-executing performance parameters set forth by the scheme and checking the transaction against one or more authorized expenditures that are encoded within context packets. For example, these context packets might specify that funds transferred to the second network are to be used exclusively for purchasing specific types of goods or services, thus ensuring compliance with the predetermined usage conditions stipulated by the regulatory entity or corporation. In some embodiments, the proof of usage model acts as a rigorous filter to ensure that the funds or digital assets are utilized exactly as intended by the originating scheme, adhering strictly to all specified conditions. This ensures that the transactions on the second DLT network not only conform to technical and operational standards but also adhere to the defined purpose and restrictions of the funds as determined by the regulatory guidelines.

In some embodiments, when the proof of usage model is applied to an exchange on the second DLT network, it ensures that transactions comply with the defined usage criteria. In some embodiments, this model is attached to each transaction or purchase as it occurs. For example, when a beneficiary, having received funds, attempts a transaction with a merchant participating node, such as an online gambling site, the transaction is scrutinized under the proof of usage model. This model can be managed by the merchant network computing system (i.e., the merchant discrete manager). The merchant discrete manager is responsible for assessing the transaction, not merely from the perspective of double-spending but also in terms of adherence to the proof of usage criteria. This can include the processing circuits verifying whether the transaction aligns with the authorized uses of the funds, as determined by the scheme and encoded within the context packets. If the transaction, such as gambling in this instance, falls outside of the authorized expenditures, the merchant discrete manager will not approve it, thereby preventing misuse of the funds as per the scheme's restrictions. In these embodiments, the process of signing, stamping, or approving the transaction by the merchant network computing system includes the processing circuits analyzing the transaction details against the context packets and checks for compliance with the specific conditions attached to the funds. This could include assessing whether the purchase category is permissible (e.g., verifying if gambling is an excluded category in the context packets).

In some embodiments, the context packets correspond to digitally encoded metadata including the one or more authorized expenditures for usage of the funds or digital asset under the scheme. Specifically, one or more authorized expenditures correspond with a merchant specific data structure including an authorized list of goods or services, or identifiers or values corresponding with the authorized list of goods or services. The authorized list of goods or services can include a merchant type associated with the merchant. The merchant type can include, for example, a groceries merchant, a clothes merchant, an arm dealer, or the like. In some embodiments, the context packets are structured as digitally encoded metadata which encapsulate detailed information about the authorized expenditures under a given scheme. This metadata is structured to provide clear and unambiguous guidelines about the permissible use of funds or digital assets. For example, a context packet may include a merchant-specific data structure that lists authorized goods or services. This list can detail categories or specific items that are permissible for purchase with the funds. Additionally, the context packet may contain identifiers or values that correspond directly with this authorized list. These identifiers serve as reference points that the DLT network's processing circuits can use to automatically verify the compliance of transactions against the scheme's conditions. For example, a transaction involving the purchase of educational materials would be cross-referenced with the identifiers in the context packet to confirm its validity under an education-focused disbursement scheme.

Furthermore, the configuration of these context packets allows for the dynamic and flexible management of authorized expenditures. In some embodiments, the processing circuits are capable of updating the context packets in response to changes in the scheme or regulatory adjustments. Specifically, the data structure of the context packets can be modified to add, remove, or alter the list of authorized goods or services as the scheme evolves. For example, if a new category of allowable expenditure is added to the scheme, the corresponding changes are reflected in the context packets, thereby updating the guidelines for future transactions. This dynamic nature of the context packets ensures that the DLT network remains responsive to the changing requirements of the scheme and continues to enforce the authorized expenditures accurately and efficiently.

Referring to the proof of usage model in greater detail. In the first DLT network, the processing circuits can be configured to maintain the proof of usage model on a first DLT network of the plurality of DLT networks. In some embodiments, maintaining the proof of usage model includes dynamically updating one or more usage conditions of the protection parameter in response to at least one change in a rule or policy by a regulatory computing system and dynamically updating a data structure of the exchange to include a proof of usage indicator corresponding with a current compliance status of the exchange based on the enforced protection parameter. In some embodiments, the proof of usage indicator is based on artefacts attached to the blocks in the blockchain on the first DLT network. In the second DLT network, the processing circuits can be configured to maintain the proof of usage model on a second DLT network. In some embodiments, maintaining the proof of usage model includes integrating context packets encoded with one or more authorized expenditures into one or more smart contracts corresponding with enforcing the one or more authorized expenditures on the funds or digital asset on the second DLT network and analyzing and authorizing the exchange based on satisfying the one or more usage conditions of the protection parameter and the one or more authorized expenditures encoded within context packets.

In some embodiments, upon receiving an indication of an emergency from a regulatory computing system, the at least one processing circuit updates the one or more usage conditions based on an updated scheme provide by the regulatory computing system, and wherein executing the disbursement of the funds or digital asset is in response to receiving a disbursement request based on the scheme. In some embodiments, the processing circuits can determine which funds or digital assets may be affected by the update. Specifically, when the processing circuits receive an indication of an emergency from a regulatory computing system, the processing circuits can initiate a sequence of actions to update the usage conditions of funds or digital assets. In some embodiments, this update is based on a revised scheme provided by the regulatory computing system, which may reflect changes in policies or urgent needs due to the emergency situation. For example, in response to a natural disaster, the regulatory computing system might issue an updated scheme that relaxes certain restrictions on fund usage, allowing for the purchase of emergency supplies. The processing circuits then determine which funds or digital assets are affected by this update by analyzing the current allocations and usage conditions within the blockchain ledger. This can include scanning the ledger entries and identifying the funds or assets that are tagged with conditions or parameters corresponding to the original scheme, which are now subject to modification.

In some embodiments, the processing circuits can disseminate the updated scheme across the DLT networks. This dissemination includes either updating existing blocks in the blockchain with the revised usage conditions or creating new blocks that encapsulate transactions under the updated scheme. For example, if the change in the scheme includes adding new categories of permissible expenditures, the processing circuits can update the smart contracts within the block headers to reflect these additions. The updated smart contracts, encoded in the block headers, now carry the new protection parameters that align with the emergency-modified scheme. Additionally, in embodiments where the scheme change is substantial, new blocks may be created to record transactions under the new guidelines, ensuring a clear demarcation between transactions governed by the original scheme and those under the updated emergency scheme.

In some embodiments, various options are available to facilitate the updates in smart contracts. One option includes the government pushing policy changes using an established protocol that the network computing system can interpret and apply. Another option employs hot key identification, where specific keys or signals are used to trigger updates in the smart contracts. In yet another option, the processing circuits utilizes Rectified Linear Units (ReLUs) to interpret text from regulatory computing systems. This method can include the processing circuits using ReLUs to analyze textual policy updates, identifying key changes and their implications. The output from the ReLUs can provide a summarized statement of the policy changes, highlighting the aspects that need to be reflected in the smart contracts. For example, if a regulatory body releases a new document on subsidy allocations, the ReLUs can process this text to extract essential updates, which are then used to adjust the smart contracts accordingly.

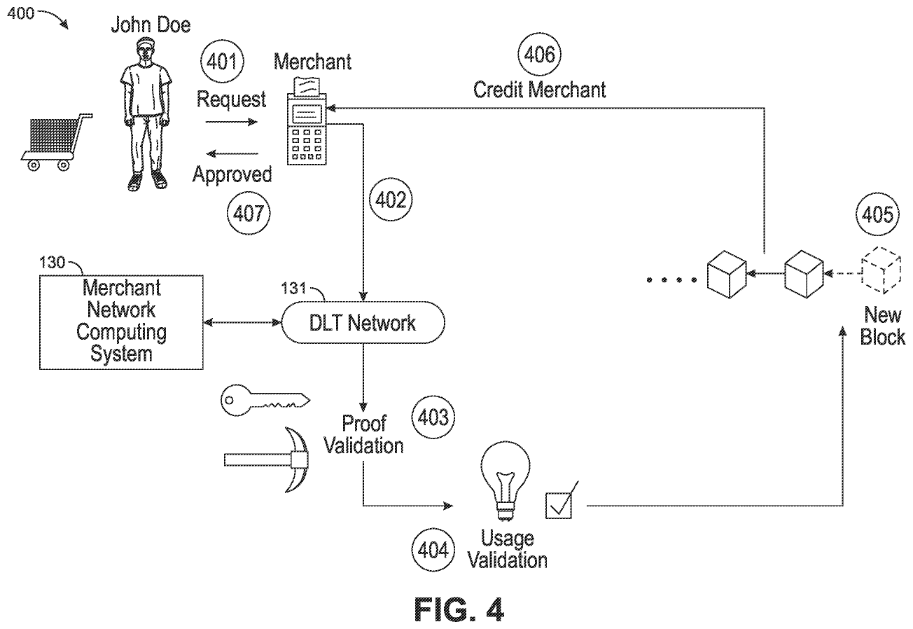

Referring now to FIG. 4, a block diagram illustrating a PoU process 400, according to some arrangements. Referring to exchanging funds from one DLT network to another DLT network in greater detail. An exchange begins with the processing circuits associated with the first DLT network receiving an exchange request from a user (e.g., merchant on a second DLT network). This request specifies an amount of a digital asset (MBC) to be exchanged to the second DLT network (e.g., merchant participating node). The processing circuits verify the availability of the specified amount of MBC in the user's account on the first DLT network. To secure the transaction, a locking mechanism is initiated on the first DLT network, temporarily securing or debiting the specified amount of MBC. This prevents its use in other exchanges on the first DLT network. An exchange record is then generated by the processing circuits, including a source identifier, a destination identifier, and the amount of MBC. In some embodiments, the exchange record is authorized using a consensus mechanism and a proof of usage mechanism of the first DLT network. The proof of usage mechanism in this network ensures compliance with the protection parameter, which includes checking for adherence to specific usage conditions such as category, geographical, and temporal restrictions. Upon authorization, the processing circuits create a new block on the first DLT network containing the authorized exchange record and add it to the blockchain.

Following this, an exchange notification containing the exchange record is transmitted to a gateway interface, facilitating communication between the first and second DLT networks. Upon reaching the second DLT network, the processing circuits there receive the exchange notification and validates it using their consensus mechanism and proof of usage mechanism. On the second DLT network, the proof of usage mechanism can include compliance with the protection parameters and adherence to authorized expenditures as encoded within context packets. This ensures that transactions on the second network comply with both the general transaction rules (protection parameters) and specific usage conditions (authorized expenditures). In some embodiments, after validation on the second DLT network, the specified amount of MBC is credited to a recipient's account. The processing circuits then generate a confirmation block, including a record of the credited amount, and add it to the blockchain of the second DLT network, thereby completing the exchange from the first DLT network to the second DLT network.

Additionally, in the described exchange process involving digital assets across DLT networks, public and private key pairs are employed to ensure transaction security and validation. A user's private key signs the exchange request, encrypting transaction details and authenticating the user's ownership of the digital asset. This signature is used in initiating a secure and verified transactions on the first DLT network. Upon receipt by the second DLT network, the corresponding public key is used to decrypt and validate the exchange notification. This validation process authenticates the transaction and confirms its integrity. Additionally, the creation of new blocks on the blockchain in both networks leverages these key pairs for encryption and verification, reinforcing the security and reliability of the blockchain ledger.

Referring now to PoU process 400, the steps include a customer, John Doe, initiating a purchase request for clothing or food at a merchant. At step 401, John Doe submits this request, which is then forwarded by the merchant to DLT network 131 at step 402. The merchant, having a participating node on DLT network 131, uses the merchant network computing system 130 to further forward or submit this request to another DLT network, such as DLT network 121. Upon receiving an indication of authorization from DLT network 121, DLT network 131 performs a proof validation process at step 403, executing a consensus model such as proof of work or proof of stake. Subsequently, at step 404, the merchant network computing system 130 and/or one or more nodes of DLT network 131, perform a usage validation by executing the Proof of Usage (PoU) model. At step 405, upon successful validation, the transaction is authorized, leading to the creation of a new block within the blockchain of DLT network 131. At step 406, the merchant is then notified by a processing circuit of DLT network 131 that their wallet or account has been credited, thus completing the approval process at step 407.

In an alternative scenario, if John Doe attempts to use his funds for gambling with a merchant, a different outcome occurs. Although the transaction may pass the initial validation using the consensus model in both DLT networks 131 and 121, it would ultimately be denied based on the PoU model. The PoU model, being encoded with specific authorized expenditures and usage conditions, would identify the gambling transaction as non-compliant with the predetermined usage criteria. As a result, despite achieving consensus, the transaction would be disapproved.

Referring now to FIG. 5, a block diagram illustrating PoU integration into a blockchain 500, according to some arrangements. Generally, a blockchain includes a series of interconnected blocks, each containing a distinct set of data and metadata. As shown, block 510 in blockchain 500 is identified by a unique identifier, referred to as “Hash 1” (e.g., a cryptographic hash representing the block's content). Block 520, the subsequent block in blockchain 500, is linked to block 510 through the incorporation of “Hash 1” from Block 510. Similarly, Block 530, the next sequential block, is connected to Block 520 via “Hash 2” of Block 520, forming a continuous chain of blocks.

In some embodiments, each block in the blockchain is structured to include a header that contains information for the network's functionality and security. The block header can include a hash reference to the previous block. Additionally, the block header incorporates a consensus proof certificate or similar validation tool. This certificate represents the agreement of the network nodes on the validity of the block's transactions, achieved through the consensus model employed by blockchain 500 (e.g., Proof of Work, Proof of Stake). Furthermore, a feature in the block header is the inclusion of a proof of usage (PoU) certificate or similar authorization token. This PoU certificate is a component for enforcing the usage conditions of the funds or digital assets associated with the block. For example, the PoU certificate might encode specific restrictions or permissions relating to the transaction, such as category, geographical, or temporal limitations, based on the scheme under which the funds were disbursed. It should also be understood that while the block header contains these elements, additional data can also be stored within the block header as well as in the block's main body (i.e., block data).

Within blockchain 500, the Proof of Usage (PoU) data can include one or more smart contracts, which are encoded with specific protection parameters and/or authorized expenses as outlined in context packets. These smart contracts, embedded within the PoU portion of the block header, can govern the transactions on the blockchain. In some embodiments, the smart contracts can be programmed to automatically execute when certain predefined conditions, encapsulated within the protection parameters and authorized expenses, are met. For example, a smart contract might be set to validate a transaction only if it falls under the permissible categories of expenses detailed in the context packets. Upon successful execution, these smart contracts can generate a certificate or token, which serves as a confirmation of compliance with the stipulated usage conditions. This certificate or token can provide a verifiable record that the transaction adhered to the guidelines or rules, thereby upholding the integrity of the PoU model within blockchain 500.

In the context of blockchain 500, each participant in the blockchain network can possess a unique pair of keys: a private key, which is kept confidential, and a public key, which is shared openly on the network. For example, when a user initiates a transaction, such as transferring digital assets (e.g., from the bank to a merchant), they sign the transaction with their private key. This signature acts as a secure digital fingerprint, verifying the transaction's origin and authenticity. The public key, which is associated with the user's blockchain address, is then used by other network participants to verify the signature. If the signature matches the public key, it confirms that the transaction was indeed created by the holder of the corresponding private key and has not been altered since it was signed.

While this specification contains many specific implementation details and/or arrangement details, these should not be construed as limitations on the scope of any disclosure or of what may be claimed, but rather as descriptions of features specific to particular implementations and/or arrangements of the systems and methods described herein. Certain features that are described in this specification in the context of separate implementations and/or arrangements can also be implemented and/or arranged in combination in a single implementation and/or arrangement. Conversely, various features that are described in the context of a single implementation and/or arrangement can also be implemented and arranged in multiple implementations and/or arrangements separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Additionally, features described with respect to particular headings may be utilized with respect to and/or in combination with illustrative arrangement described under other headings; headings, where provided, are included solely for the purpose of readability and should not be construed as limiting any features provided with respect to such headings.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations and/or arrangements described above should not be understood as requiring such separation in all implementations and/or arrangements, and it should be understood that the described program components and systems can generally be integrated together in a single software product or packaged into multiple software products.

Having now described some illustrative implementations, implementations, illustrative arrangements, and arrangements it is apparent that the foregoing is illustrative and not limiting, having been presented by way of example. In particular, although many of the examples presented herein involve specific combinations of method acts or system elements, those acts, and those elements may be combined in other ways to accomplish the same objectives. Acts, elements and features discussed only in connection with one implementation and/or arrangement are not intended to be excluded from a similar role in other implementations or arrangements.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations and/or arrangements consisting of the items listed thereafter exclusively. In one arrangement, the systems and methods described herein consist of one, each combination of more than one, or all of the described elements, acts, or components.

Any references to implementations, arrangements, or elements or acts of the systems and methods herein referred to in the singular may also embrace implementations and/or arrangements including a plurality of these elements, and any references in plural to any implementation, arrangement, or element or act herein may also embrace implementations and/or arrangements including only a single element. References in the singular or plural form are not intended to limit the presently disclosed systems or methods, their components, acts, or elements to single or plural configurations. References to any act or element being based on any information, act or element may include implementations and/or arrangements where the act or element is based at least in part on any information, act, or element.

Any implementation disclosed herein may be combined with any other implementation, and references to “an implementation,” “some implementations,” “an alternate implementation,” “various implementation,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

Any arrangement disclosed herein may be combined with any other arrangement, and references to “an arrangement,” “some arrangements,” “an alternate arrangement,” “various arrangements,” “one arrangement” or the like are not necessarily mutually exclusive and are intended to indicate that a particular feature, structure, or characteristic described in connection with the arrangement may be included in at least one arrangement. Such terms as used herein are not necessarily all referring to the same arrangement. Any arrangement may be combined with any other arrangement, inclusively or exclusively, in any manner consistent with the aspects and arrangements disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations and/or arrangements are illustrative rather than limiting of the described systems and methods. Scope of the systems and methods described herein is thus indicated by the appended claims, rather than the foregoing description, and changes that come within the meaning and range of equivalency of the claims are embraced therein.

It should be understood that no claim element herein is to be construed under the provisions of 35 U.S.C. § 112(f) unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively, or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor. In some embodiments, the one or more processors may be external to the apparatus, for example the one or more processors may be a remote processor (e.g., a cloud based processor). Alternatively, or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), math-based currencies (often referred to as cryptocurrencies), and central bank digital currency (often referred to as CBDC). Examples of math-based currencies include Bitcoin, Ethereum, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

What is claimed is:

1. A system, comprising:
memory and at least one processing circuit configured to:
generate a plurality of distributed ledger technology (DLT) networks;
activate and connect a first network computing system to at least one of the DLT networks;
activate and connect a second network computing system to at least one of the DLT networks;
execute a disbursement of funds or digital asset corresponding with the first network computing system;
append a protection parameter to the funds or digital asset on at least one of the DLT networks based on a scheme, the scheme corresponding to restrictions on one or more usages of the funds or digital asset; and
in response to receiving an exchange request from the second network computing system, authorize an exchange for at least a portion of the funds or digital asset based on at least a consensus model and a proof of usage model on at least two of the plurality of DLT networks, wherein the proof of usage model authorization occurs by at least one of the first network computing system or the second network computing system.

2. The system of claim 1, wherein:
a first DLT network of the plurality of DLT networks corresponds with the first network computing system;
a second DLT network of the plurality of DLT networks corresponds with the second network computing system; and
the protection parameter corresponds to executable code added to the exchange on the plurality of DLT networks by the at least one processing circuit to restrict or authorize a future exchange.

3. The system of claim 2, wherein the proof of usage model, implemented by the at least one processing circuit, comprises confirming a usage of at least the portion of the funds or digital asset based on:
complying with one or more smart contracts enforcing one or more usage conditions of the protection parameter on the first DLT network, the one or more usage conditions comprising at least one of a category restriction on the funds or digital asset, a geographical restriction on the funds or digital asset, a temporal restriction on the funds or digital asset; and
adhering to one or more authorized expenditures encoded within context packets on the second DLT network.

4. The system of claim 3, wherein the context packets correspond to digitally encoded metadata comprising the one or more authorized expenditures for usage of the funds or digital asset under the scheme, the one or more authorized expenditures correspond with a merchant specific data structure comprising an authorized list of goods or services, or identifiers or values corresponding with the authorized list of goods or services.

5. The system of claim 2, wherein the first network computing system and the second network computing system are external to the plurality of DLT networks, and wherein activating and connecting comprises:
initializing operational parameters of the first network computing system and the second network computing system; and
establishing a plurality of communication channels with participating nodes within the first DLT network and the second DLT network.

6. The system of claim 1, wherein the at least one processing circuit further configured to:
maintain, by the first network computing system, the proof of usage model on a first DLT network of the plurality of DLT networks, wherein maintaining the proof of usage model comprises:
dynamically updating one or more usage conditions of the protection parameter in response to at least one change in a rule or policy by a regulatory computing system; and
dynamically updating a data structure of the exchange to include a proof of usage indicator corresponding with a current compliance status of the exchange based on the enforced protection parameter.

7. The system of claim 6, wherein the at least one processing circuit further configured to:
maintain, by the second network computing system, the proof of usage model on a second DLT network, wherein maintaining the proof of usage model comprises:
integrating context packets encoded with one or more authorized expenditures into one or more smart contracts corresponding with enforcing the one or more authorized expenditures on the funds or digital asset on the second DLT network; and
analyzing and authorizing the exchange based on satisfying the one or more usage conditions of the protection parameter and the one or more authorized expenditures encoded within context packets.

8. The system of claim 1, wherein:
a first DLT network of the plurality of DLT networks comprises an initiating participating node, a facilitating participating node, and a plurality of beneficiary participating nodes:
the initiating participating node configured to initiate fund or digital asset disbursement exchanges;
the facilitating participating node configured to execute one or more smart contracts corresponding with the fund or digital asset disbursement and append the exchange to comprise the protection parameter based on the scheme;
the plurality of beneficiary participating nodes configured to receive and authorize the exchange of at least the portion of the funds or digital asset in accordance with the protection parameter; and
a second DLT network of the plurality of DLT networks comprises a plurality of merchant participating nodes, the plurality of merchant participating nodes configured to authorize the exchange based on the proof of usage model provided by the second network computing system and execute, using the consensus model, consensus decision-making for exchange authorization or rejection.

9. A system of claim 1, wherein upon receiving an indication of an emergency from a regulatory computing system, the at least one processing circuit updates the one or more usage conditions based on an updated scheme provide by the regulatory computing system, and wherein executing the disbursement of the funds or digital asset is in response to receiving a disbursement request based on the scheme.

10. A system, comprising:
at least one integration computing system configured to:
generate a first distributed ledger technology (DLT) network comprising a plurality of beneficiary participating nodes;
generate a second DLT network comprising a plurality of merchant participating nodes;
activate and connect a beneficiary network computing system to the first DLT network;
activate and connect a merchant network computing system to the second DLT network;
receive a disbursement request based on a scheme;
the beneficiary network computing system configured to:
execute, on the first DLT network, a disbursement corresponding with funds or digital asset based on the disbursement request;
append a protection parameter based on the scheme to the funds or digital asset;
store, on a ledger of the first DLT network, the funds or digital asset;
in response to receiving an exchange request for an exchange from at least one of the plurality of merchant participating nodes, authorize the exchange for at least a portion of the funds or digital asset on the first DLT network based on at least a first consensus model and a proof of usage model;
the merchant network computing system configured to:
provide the exchange request to the at least one integration computing system for at least the portion of the funds or digital asset; and
in response to receiving an indication of authorization of the exchange on the first DLT network, authorize the exchange on the second DLT network for at least the portion of the funds or digital asset based on at least a second consensus model and the proof of usage model.

11. The system of claim 10, wherein the protection parameter corresponds to executable code added to the exchange on the first DLT network by the beneficiary network computing system to restrict or authorize a future exchange, and wherein the first consensus model is different from the second consensus model.

12. The system of claim 10, wherein the proof of usage model, implemented by the beneficiary network computing system and the merchant network computing system, comprises confirming a usage of at least the portion of the funds or digital asset based on:
complying with one or more smart contracts enforcing one or more usage conditions of the protection parameter on the first DLT network, the one or more usage conditions comprises at least one of a category restriction on the funds or digital asset, a geographical restriction on the funds or digital asset, a temporal restriction on the funds or digital asset, and wherein upon receiving an indication of an emergency from a regulatory computing system, the at least one processing circuit updates the one or more usage conditions based on an updated scheme provide by the regulatory computing system; and
adhering to one or more authorized expenditures encoded within context packets on the second DLT network.

13. The system of claim 12, wherein the context packets correspond to digitally encoded metadata comprising the one or more authorized expenditures for usage of the funds or digital asset under the scheme, the one or more authorized expenditures correspond with a merchant specific data structure comprising an authorized list of goods or services, or identifiers or values corresponding with the authorized list of goods or services.

14. The system of claim 10, wherein the beneficiary network computing system and the merchant network computing system are external to the first DLT network and the second DLT network, and wherein activating and connecting comprises:
initializing operational parameters of the beneficiary network computing system and the merchant network computing system; and
establishing a plurality of communication channels with participating nodes within the first DLT network and the second DLT network.

15. The system of claim 10, wherein:
the first DLT network comprises an initiating participating node, a facilitating participating node, and the plurality of beneficiary participating nodes:
the initiating participating node configured to initiate fund or digital asset disbursement exchanges;
the facilitating participating node configured to execute one or more smart contracts corresponding with the fund or digital asset disbursement and append the exchange to comprise the protection parameter based on the scheme;
the plurality of beneficiary participating nodes configured to receive and authorize the exchange of at least the portion of the funds or digital asset in accordance with the protection parameter; and
the second DLT network comprises the plurality of merchant participating nodes, the plurality of merchant participating nodes configured to authorize the exchange based on the proof of usage model provided by the merchant network computing system and execute, using the second consensus model, consensus decision-making for exchange authorization or rejection.

16. A method, comprising:
generating, by at least one processing circuit, a plurality of DLT networks;
activating, by the at least one processing circuit, and connect a first network computing system on at least one of the DLT networks;
activating, by the at least one processing circuit, and connect a second network computing system on at least one of the DLT networks;
executing, by the at least one processing circuit, a disbursement of funds or digital asset corresponding with the first network computing system;
appending, by the at least one processing circuit, a protection parameter to the funds or digital asset on at least one of the DLT networks based on a scheme, the scheme corresponding to restrictions on one or more usages of the funds or digital asset; and
in response to receiving an exchange request from the second network computing system, authorizing, by the at least one processing circuit, an exchange for at least a portion of the funds or digital asset based on at least a consensus model and a proof of usage model on at least two of the plurality of DLT networks, wherein the proof of usage model authorization occurs by at least one of the first network computing system or the second network computing system.

17. The method of claim 16, wherein:
a first DLT network of the plurality of DLT networks corresponds with the first network computing system;
a second DLT network of the plurality of DLT networks corresponds with the second network computing system; and
the protection parameter corresponds to executable code added to the exchange on the plurality of DLT networks by the at least one processing circuit to restrict or authorize a future exchange.

18. The method of claim 17, wherein the proof of usage model, implemented by the at least one processing circuit, comprises confirming a usage of at least the portion of the funds or digital asset based on:
complying, by the at least one processing circuit, with one or more smart contracts enforcing one or more usage conditions of the protection parameter on the first DLT network, the one or more usage conditions comprising at least one of a category restriction on the funds or digital asset, a geographical restriction on the funds or digital asset, a temporal restriction on the funds or digital asset; and
adhering, by the at least one processing circuit, to one or more authorized expenditures encoded within context packets on the second DLT network.

19. The method of claim 18, wherein the context packets correspond to digitally encoded metadata comprising the one or more authorized expenditures for usage of the funds or digital asset under the scheme, the one or more authorized expenditures correspond with a merchant specific data structure comprising an authorized list of goods or services, or identifiers or values corresponding with the authorized list of goods or services.

20. The method of claim 17, wherein the first network computing system and the second network computing system are external to the plurality of DLT networks, and wherein activating and connecting comprises:
initializing, by the at least one processing circuit, operational parameters of the first network computing system and the second network computing system; and
establishing, by the at least one processing circuit, a plurality of communication channels with participating nodes within the first DLT network and the second DLT network.
